(19) United States
(12) Patent Application Publication
(10) Pub. No.: US 2025/0211693 A1
(43) Pub. Date: Jun. 26, 2025

(54) READING DEVICE FOR RECEIVING AUTHENTICATION INFORMATION THROUGH USER INTERFACE TO PERMIT CANCELLING ONGOING PULL SCAN

(71) Applicant: BROTHER KOGYO KABUSHIKI KAISHA, Nagoya (JP)

(72) Inventor: Thanh NGUYENVAN, Nagoya (JP)

(21) Appl. No.: 18/960,296

(22) Filed: Nov. 26, 2024

(30) Foreign Application Priority Data
Dec. 26, 2023 (JP) 2023-219600

(51) Int. Cl. H04N 1/00

(52) U.S. Cl. CPC H04N 1/00875; H04N 1/00854

(57) ABSTRACT

A reading device includes a scanner, a user interface, and a controller. The controller starts a pull scan based on the execution instruction under a start condition. The start condition includes a requirement that first user authentication information is received in association with the execution instruction. The controller cancels the started pull scan under a cancellation condition. The cancellation condition includes: a requirement that a cancellation instruction to cancel the pull scan is received through the user interface; a requirement that second user authentication information is received through the user interface in association with the cancellation instruction; and a requirement that the second user authentication information corresponds to the first user authentication information. Despite receiving the cancellation instruction, the controller continues the pull scan under a continuation condition including a requirement that the second user authentication information does not correspond to the first user authentication information.

### REFERENCE TO RELATED APPLICATIONS

This application claims priority from Japanese Patent Application No. 2023-219600 filed on Dec. 26, 2023. The entire content of the priority application is incorporated herein by reference.

### BACKGROUND ART

A conventionally known reading device can perform a pull scan by controlling a scanner to read a document in response to an execution instruction received from an external device. A list of users permitted to execute pull scans is registered on the reading device in advance. When the reading device receives an instruction to execute a pull scan, the device performs an authentication process to determine whether the user that issued the execution instruction matches a registered user. When authentication is successful, the reading device begins the pull scan operation.

### SUMMARY

Occasionally, the user of such a reading device may wish to cancel a scan after issuing an execution instruction. It is conceivable that the reading device should determine which users are permitted to issue a cancellation instruction to handle such a situation. However, the description of the conventional device does not cover this process and, hence, the above technology has room for improvement in this regard.

In view of the foregoing, it is an object of the present disclosure to provide a reading device capable of permitting only appropriate users to cancel a scanning operation.

In order to attain the above and other object, the present disclosure provides a reading device. The reading device includes a scanner, a user interface, and a controller. The controller is configured to perform: receiving an execution instruction issued from an external device, the execution instruction instructing the controller to perform a pull scan, the pull scan including: controlling the scanner to read an original to generate scan data based on the original; and returning the scan data to the external device; starting a first pull scan, the first pull scan being the pull scan based on the execution instruction and started under a pull scan start condition, the pull scan start condition including a requirement that first user authentication information is received in association with the execution instruction; and cancelling the started first pull scan under a first cancellation condition, the first cancellation condition including: a requirement that a cancellation instruction to cancel the pull scan is received through the user interface after starting the first pull scan; a requirement that second user authentication information is received through the user interface in association with the cancellation instruction; and a requirement that the second user authentication information corresponds to the first user authentication information received in association with the execution instruction. Despite receiving the cancellation instruction after starting the first pull scan, the controller continues the first pull scan under a first continuation condition. The first continuation condition includes: a requirement that the cancellation instruction is received through the user interface; a requirement that the second user authentication information is received through the user interface in association with the cancellation instruction; and a requirement that the second user authentication information does not correspond to the first user authentication information received in association with the execution instruction.

In the above structure, the reading device can allow an appropriate user to cancel the started scan.

### BRIEF DESCRIPTION OF DRAWINGS

FIG. 1 is a block diagram illustrating a configuration of a multifunction peripheral (MFP).

FIG. 2 is an explanatory diagram illustrating a restriction configuration screen.

FIG. 3 is a flowchart illustrating a scan control process executed by the MFP.

FIG. 4 is a flowchart illustrating details of a scan request process of S2 shown in FIG. 3.

FIG. 5 is a flowchart illustrating details of a push scan request process of S11 shown in FIG. 4.

FIG. 6 is a flowchart illustrating details of a pull scan request process of S12 shown in FIG. 4.

FIG. 7 is a flowchart illustrating details of a user authentication need identification process of S32 shown in FIG. 6.

FIG. 8 is a flowchart illustrating details of a user authentication process of S36 shown in FIG. 6.

FIG. 9 is a flowchart illustrating details of a scan permission confirmation process of S38 shown in FIG. 6.

FIG. 10 is a flowchart illustrating details of an error monitoring process of S4 shown in FIG. 3.

FIG. 11 is a flowchart illustrating details of a job cancellation request process of S6 shown in FIG. 3.

FIG. 12 is a flowchart illustrating details of a job cancellation process of S88 of FIG. 11, S96 of FIG. 13, and S104 of FIG. 14.

FIG. 13 is a flowchart illustrating details of a pull scan job cancellation process of S87 shown in FIG. 11.

FIG. 14 is a flowchart illustrating details of a cancellation control process of S95 shown in FIG. 13.

FIG. 15 is a flowchart illustrating details of a job cancellation permission process of S101 shown in FIG. 14.

FIG. 16 is a flowchart illustrating details of a cancelling user confirmation process of S117 shown in FIG. 15.

FIG. 17 is a flowchart illustrating details of a job cancellation permission determination process of S116 shown in FIG. 15.

FIG. 18A is an explanatory diagram illustrating a standby screen displayed on a user interface of MFP.

FIG. 18B is an explanatory diagram illustrating a user selection screen displayed on the user interface.

FIG. 18C is an explanatory diagram illustrating a password entry screen displayed on the user interface.

FIG. 18D is an explanatory diagram illustrating a post-login standby screen displayed on the user interface.

FIG. 18E is an explanatory diagram illustrating a scan-in-progress screen displayed on the user interface.

FIG. 18F is an explanatory diagram illustrating a cancellation acceptance screen displayed on the user interface.

### DESCRIPTION

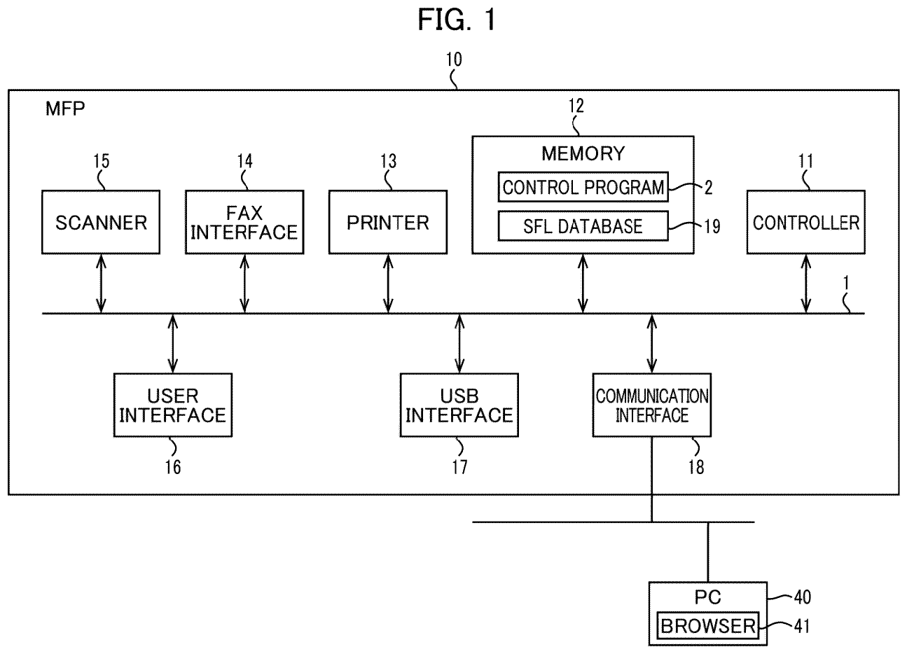

Next, a multifunction peripheral (MFP) 10 will be described as an embodiment of the reading device. As shown in FIG. 1, the MFP 10 is provided with a controller 11, a memory 12, a printer 13, a fax interface 14, a scanner 15, a user interface 16, a USB interface 17, and a communication interface 18. These components are interconnected via a bus 1 and can communicate with one another.

The printer 13 prints images on recording media such as sheets or discs. Examples of sheets include paper and transparencies. The printer 13 may print using an inkjet method, an electrophotographic method, or the like. The scanner 15 has an image sensor, such as a charge-coupled device (CCD) or a contract image sensor (CIS), that generates image data by reading an original document.

The user interface 16 can accept various operations for the MFP 10. The user interface 16 includes a touchscreen with a liquid crystal display, and various operating keys. The operating keys include a Cancel key described later. The Cancel key is a hardware key. However, a software key displayed on the touchscreen may be provided as the Cancel key in place of a hardware key, or both a hardware key and a software key may be provided as the Cancel key. A USB-compliant storage medium or the like can be detachably connected to the USB interface 17, whereby the USB interface 17 can read data from and write data to the storage medium through communications conforming to the USB standard. A USB-compliant storage medium is a USB memory device, for example. The MFP 10 connects to a network via the communication interface 18 and communicates with a PC 40 over the network according to a predetermined protocol (e.g., TCP/IP). The communication interface 18 may be configured of a wired or wireless LAN interface or the like.

The controller 11 is a processing device (a processor) provided with a CPU and the like, for example. The memory 12 is configured of a combination of volatile memory such as RAM, nonvolatile memory such as NVRAM, ROM, and the like. A solid-state drive (SSD), a hard disk drive (HDD), and the like may also be used as nonvolatile memory. The controller 11 is also provided with a buffer that may be considered a part of the memory 12. The controller 11 uses the buffer when executing the various programs. The memory 12 may also be a storage medium that can be read by the controller 11. A storage medium that is readable by the controller 11 is a non-transitory medium. In addition to the above examples, non-transitory media include CD-ROM and DVD-ROM. A non-transitory medium is also a tangible medium. On the other hand, electric signals that convey programs downloaded from a server or the like on the Internet are a computer-readable signal medium, which is one type of computer-readable medium but is not considered a non-transitory storage medium.

The memory 12 stores a control program 2 that is executable by the controller 11. The control program 2 is firmware that implements overall control of the components in the MFP 10, for example. By executing the control program 2, the controller 11 controls each device connected to the bus 1. The present embodiment primarily describes processes executed by the controller 11 according to instructions described in programs. In other words, actions such as “determine,” “identify,” “acquire,” “accept,” and “control” in the following description represent processes performed by the controller 11. Note that the term “acquire” in this specification is used as a concept that does not necessarily require a request. In other words, a process by which the controller 11 receives data without requesting that data is included in the concept of “the controller 11 acquires data.” The term “data” used in this specification denotes a bit string that can be read by the controller 11. Data of different formats but having essentially the same semantic content will be treated as the same data. The same treatment will be applied to “information” in this specification.

The control program 2 also includes an embedded web server (EWS) program that functions as a web server, for example. By executing the EWS program, the controller 11 can control the MFP 10 to function as a web server. “EWS” will be used to refer to the web server implemented with the MFP 10. The controller 11, functioning as the web server for example, transmits web page data for displaying web pages to the PC 40, enabling a browser 41 of the PC 40 described later to display the prescribed web pages. The transmission of web page data will also be described as supplying web pages.

Next, the configuration of the PC 40 will be described. While not shown in the drawings, the PC 40 is provided with a communication interface, a memory, a controller (a processor), a display, and a user interface. The memory of the PC 40 stores an operating system (OS) and a browser 41. The browser 41 can display a web page on the display of the PC 40 based on web page data received from the MFP 10. The PC 40 is the example of the external device. Note that the external device communicating with the MFP 10 is not limited to the PC 40 but may be a device capable of transmitting an instruction to the MFP 10 to execute a pull scan described later, such as a smartphone, a tablet computer, or another portable terminal.

Next, a feature called “Secure Function Lock” will be described. The MFP 10 in the present embodiment has a Secure Function Lock feature (hereinafter referred to as the “SFL feature”). The SFL feature configures what functions of the MFP 10 are permitted and not permitted for each user and restricts the execution of functions for which a user is not permitted to use. Setting functions of the MFP 10 to “not permitted” will also be referred to as “restricting” those functions. The controller 11 accepts settings through the EWS, for example, for enabling/disabling the SFL feature, registering a user, registering a password, and restricting functions for individual users. Settings related to restricting functions may also be considered permission-related settings. Specifically, permission-related settings indicate whether or not a user is permitted to use certain functions. The controller 11 registers information received through the EWS in a SFL database 19 stored in the memory 12. The method of receiving settings is not limited to reception via the EWS but may be reception via the user interface 16.

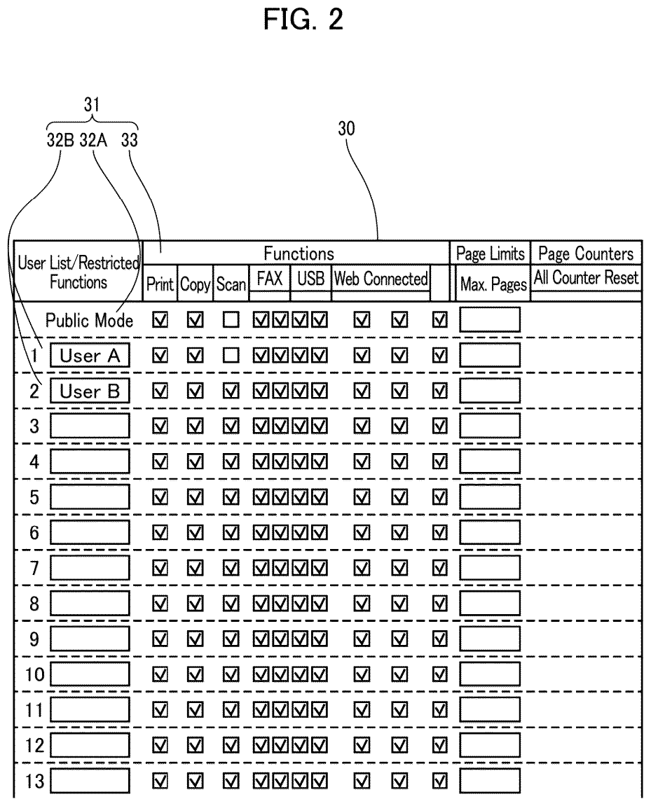

FIG. 2 shows a restriction configuration screen 30 that accepts input designating functions to be restricted and permitted for individual users. For example, the controller 11 supplies a web page to the browser 41 of the PC 40 that has access to the EWS. When an administrator performs login operations in this web page, the controller 11 supplies the PC 40 with a web page for enabling or disabling the SFL feature, and a web page showing the restriction configuration screen 30 of FIG. 2.

The restriction configuration screen 30 has a restriction designation area 31 that accept designations of users and functions to be subjected to restrictions according to the SFL feature. The restriction designation area 31 has user designation fields 32 (32A, 32B) for specifying users to be subjected to restrictions, and function designation fields 33 for specifying which functions are to be permitted or not permitted. There are a plurality of the user designation fields 32. Among them, “Public Mode” 32A is a field for which the subject of the SFL feature is users when the MFP 10 is a locally logged-out state in which no user is locally logged in to the MFP 10. In other words, this area specifies what restrictions are set without identifying a local (or offline) user. Here, the term “local” refers to a situation where the subject, such as a user, directly interacts with a device, such as the MFP 10 without relying on network connectivity. Thus, a locally logged-in state is a state in which a user is directly logged in to the MFP 10 using user interface 16.

A state that a user is logged in to the MFP 10 indicates that the MFP 10 has authenticated the user and can accept further access from the user. That is, the logged-in state, such as a locally logged-in state, refers to the condition that follows after a user has been authenticated, indicating that the authenticated user is permitted to access the MFP 10. In other words, to log in to the MFP 10, the user must be authenticated. However, while the authentication is a prerequisite for entering the logged-in state, successful authentication alone does not necessarily mean the MFP 10 is in the logged-in state. The MFP 10 is considered to be in the logged-in state when access is granted to the authenticated user.

Individual user fields 32B are fields for inputting usernames specifying users to be subjected to the SFL feature. In other words, these areas specify specific users for which restrictions are set. A function designation field 33 is provided to the right of each user designation field 32. The function designation field 33 to the right of an individual user designation field 32 is an area for indicating whether individual functions are permitted or not permitted for the user specified in the user designation field 32.

The function designation field 33 is also an area for accepting designations for functions to be restricted by the SFL feature. The function designation field 33 has checkboxes for indicating whether or not a restriction has been set for each of functions of the MFP 10, including “Print,” “Copy,” “Scan,” “Fax,” “USB,” and “Web Connected.” The “Scan” function here corresponds to push scans described later. When the “Scan” function is restricted for a user, the user cannot execute push scans and when a user is not permitted to execute push scans, the user is also not permitted to execute pull scans. All checked functions in the function designation field 33 are non-restricted functions, i.e., functions that the user is permitted to execute, while unchecked functions are restricted functions, i.e., functions that the user is not permitted to execute. The “Fax” function includes two separate functions, “Fax transmission” and “Fax reception,” with a checkbox for each. The “USB” function includes the separate functions “USB direct print” and “Scan-to-USB,” with a checkbox for each. The “Web Connected” function includes the separate functions “Upload” and “Download,” with a checkbox for each. The items of checkboxes to set restrictions are just examples.

In the example shown in FIG. 2, only the “Scan” function is unchecked in the function designation field 33 for the “Public Mode” 32A, while all other functions are checked. In this case, in the locally logged-out state in which no user is locally logged in to the MFP 10, the MFP 10 restricts the execution of the “Scan” function but does not restrict the execution of functions other than the “Scan” function. Similarly, User A and User B in the individual user fields 32B are either restricted or not restricted from using functions according to their checked status. For convenience, the phrase “restricted or not restricted” may be shortened to simply “restricted” in the following description, unless there is a possibility of confusion. While the SFL feature is enabled and the MFP 10 is in the locally logged-in state where any user is locally logged in to the MFP 10, the controller 11 restricts functions based on the settings for the locally logged-in user. Further, when the controller 11 receives an instruction from the PC 40 that requires authentication, the controller 11 restricts use of functions based on settings for the authenticated user. Once an OK button (not shown) in the restriction configuration screen 30 is operated, the controller 11 updates the values for settings in the SFL database 19 based on input received in the restriction configuration screen 30.

Note that the controller 11 may also store various settings in the memory 12 to be used in place of and/or in addition to the SFL database 19. For convenience, storing settings in the memory 12 may also be referred to as “configuring settings” or the like. Also, for convenience, the condition of settings being stored in the memory 12 may be referred to using expressions such as “settings are configured,” “settings are set,” and “settings have been configured.”

Next, steps in a process executed by the controller 11 when a user uses the “Scan” function on the MFP 10 will be described. Under the “Scan” function, the MFP 10 can execute both push scans and pull scans. The controller 11 generates scan data from image data outputted by the scanner 15 when reading a document. The scan data is one type of image data. A push scan is performed in response to an execution instruction that the user issues through operations on the user interface 16. In a push scan, the controller 11 generates scan data by controlling the scanner 15 to read a document and outputs the generated scan data to an output destination provided in the execution instruction. Because the execution instruction of the push scan is issued through the user interface 16, the output destination to which scan data is to be transmitted in the push scan is designated through the user interface 16. For example, the controller 11 transmits the scan data to the destination. The PC 40 or another device connected to the MFP 10 via the USB interface 17 or communication interface 18, for example, may be specified as the output destination for data generated in a push scan. A pull scan is performed in response to an execution instruction transmitted from an external device when the user performs operations on the external device. In a pull scan, the controller 11 generates scan data by controlling the scanner 15 to read a document and transmits the generated scan data to a device (the external device in this case) from which the execution instruction was received (a transmission source of the execution instruction). The execution instruction of the pull scan may include, as information of a destination device to which scan data is to be transmitted, information of the device that is the same as the transmission source of this execution instruction. In the present embodiment, the external device will be the PC 40.

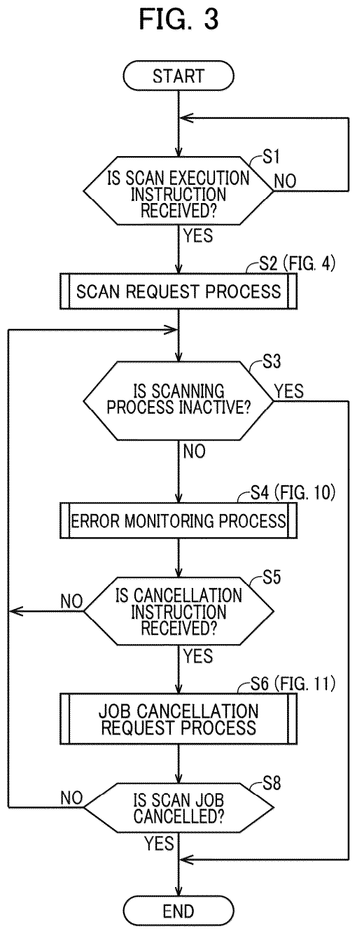

FIG. 3 shows steps in a scan control process executed by the controller 11 of the MFP 10. The controller 11 begins this scan control process when the power to the MFP 10 is turned on and the controller 11 executes the control program 2 to start up the system. However, the condition for starting the process in FIG. 3 is not limited to the system being started up. For example, the controller 11 may begin the process of FIG. 3 upon returning from a power-saving mode for suppressing power consumption. The following description will first assume that the restriction settings shown in FIG. 2 have been recorded in the SFL database 19.

In the scan control process, the controller 11 determines whether to permit scanning. Once the scanning is permitted and the scanning is started, the controller 11 can receive a cancellation instruction for cancelling (or terminating) the scanning. Further, upon receipt of the cancellation instruction, the controller 11 determines whether to permit cancelling the scan by considering whether the cancellation instruction is received locally (directly) or externally (remotely).

In step 1 (S1) of FIG. 3, the controller 11 first determines whether an execution instruction for a scan was received. Hereinafter, “step” will be abbreviated as “S”. The controller 11 repeatedly loops back to S1 while determining that an execution instruction for a push scan or a pull scan was not received (S1: NO) and executes a scan request process in S2 when determining that an execution instruction for a scan was received (S1: YES). The scan request process of S2 is a process to determine whether to permit the push or pull scan instructed in the execution instruction.

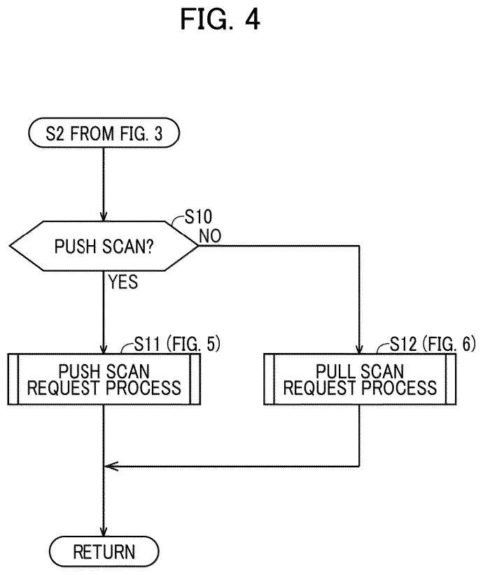

FIG. 4 shows steps in the scan request process of S2. In S10 of FIG. 4, the controller 11 determines whether an execution instruction for a push scan was received. Specifically, when an instruction to begin executing the “Scan” function was received through operations on the user interface 16 of the MFP 10, the controller 11 determines that an execution instruction for a push scan was received (S10: YES). The execution instruction for the push scan may include information of a destination device to which scan data is to be transmitted, or the execution instruction may be issued with the destination device being designated. In this case, the destination device is designated by the user interface 16. When the execution instruction is received locally through the user interface 16, for example, the controller 11 makes YES determination in S10. In this case, the controller 11 executes a push scan request process in S11. For example, the controller 11 transmits a push scan request to an external device (the PC 40 in this example), as the transmission device, upon receiving an operation on the user interface 16. Upon receiving this request, the external device returns a “Scan” instruction to the MFP 10. When the controller 11 receives this response, the controller 11 may determine that an instruction to execute a push scan was received. On the other hand, when an operation to start a scan was performed on an external device and the controller 11 received an execution instruction sent from the external device, the controller 11 determines that a pull scan execution instruction was received (S10: NO). In this case, the controller 11 executes a pull scan request process in S12.

Note that a “Scan” execution instruction may include information indicating whether the instruction is issued in response to an operation received through the user interface 16 or in response to an operation on an external device. Based on this information, the controller 11 may determine whether the execution instruction is for a push scan or a pull scan. Further, when the controller 11 determines that the instruction was received in response to an operation on the user interface 16, the controller 11 may determine that a push scan execution instruction was received and may execute the process in S11 without sending a request to the external device.

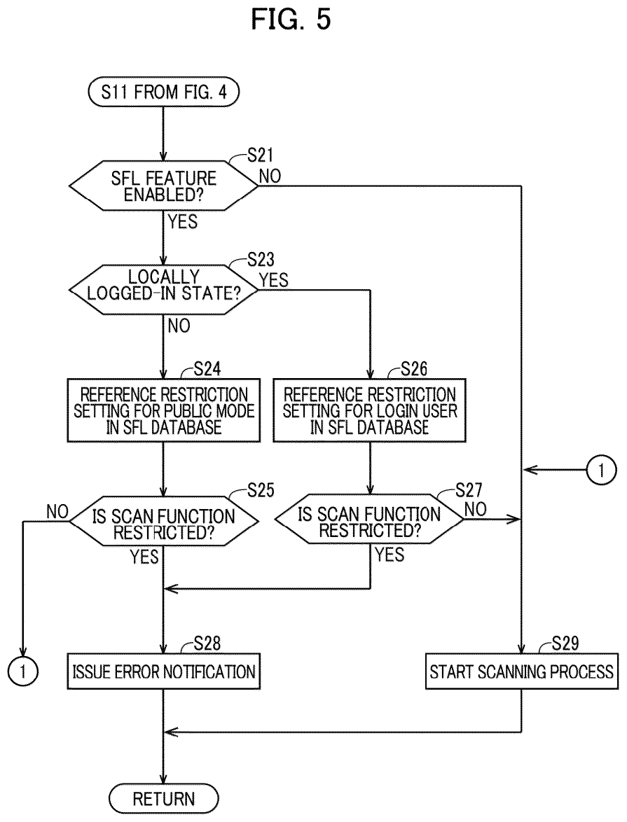

FIG. 5 shows steps in the push scan request process of S11. In this process, the controller 11 either restricts the push scan or executes the push scan without restriction depending on the restriction settings recorded in the SFL database 19. First, the process will be described for a case where the MFP 10 is in a locally logged-out state in which no user is locally logged in to the MFP 10. The locally logged-out state in which no user is locally logged in to the MFP 10 will also be referred to as the public mode for convenience. The SFL database 19 stores information specifying whether the SFL feature is enabled (ON) or disabled (OFF), for example. Hereinafter, this information will be called the SFL feature information. When the SFL feature is enabled, the MFP 10 restricts functions based on the SFL database 19 whereas when the SFL feature is disabled, the MFP does not restrict the functions. In S21 of FIG. 5, the controller 11 extracts the SFL feature information from the SFL database 19 stored in the memory 12. When the controller 11 determines that the SFL feature information is set to “disabled” (S21: NO), in S29 the controller 11 instructs the scanner 15 to start a scan in order to read a document set on the document platen. In other words, the controller 11 executes a push scan without restriction and subsequently ends the process in FIGS. 4 and 5.

The next example will assume that the SFL feature information recorded in the SFL database 19 indicates “enabled” (ON). Accordingly, the controller 11 determines that the SFL feature is enabled (S21: YES). In S23 the controller 11 checks whether the MFP 10 is in the locally logged-in state where the user has been logged in to the MFP 10 through operations on the user interface 16. Since the MFP 10 is in a locally logged-out state in this example (S23: NO), in S24 the controller 11 references the SFL database 19 to obtain the restriction setting for the “Scan” function associated with the “Public Mode” 32A.

In S25 the controller 11 determines whether the “Scan” function is restricted in the “Public Mode”. As shown in FIG. 2, since the “Scan” function under “Public Mode” is unchecked, i.e., is restricted (S25: YES), in S28 the controller 11 issues an error notification indicating that the “Scan” function cannot be executed. The controller 11 issues this notification in the present embodiment by displaying an error screen on the user interface 16 indicating that the “Scan” function cannot be executed. Thus, the controller 11 places a restriction on push scans when the MFP 10 is in the locally logged-out state. In this embodiment, a restriction on the “Scan” function means that scanning processes are not executed. However, the restriction may instead involve reducing the scanning quality or may require an administrator to perform an additional special permission operation in order to execute the scan. Subsequently, the controller 11 ends the process in FIGS. 4 and 5. When the “Scan” function under “Public Mode” is checked, i.e., is permitted (S25: NO), in S29 the controller 11 instructs the scanner 15 to start the scan. That is, the scan is performed without restriction. Once the push scan is started, the scanner 15 accumulates generated data, as part of scan data in the memory 12. The controller 11 sequentially outputs or sends the data, as part of scan data, accumulated in the memory 12 to the transmission destination such as the external device (PC 40 in this example) or the USB memory mounted on the USB interface 17 in order to output the scan data.

Next, the process will be described for a case in which User A is locally logged in to the MFP 10. Since User A is in a locally logged-in state (S23: YES), in S26 the controller 11 references the restriction setting in the SFL database 19 corresponding to the “Scan” function for User A. As shown in FIG. 2, the “Scan” function under User A is unchecked, i.e., is restricted. In S27 the controller 11 determines that the “Scan” function is restricted (S27: YES), in S28 issues an error notification indicating that the scan cannot be executed, as described earlier, and subsequently ends the processes in FIGS. 4 and 5. When User B is locally logged in to the MFP 10, on the other hand, the controller 11 determines in S27 that the “Scan” function is not restricted (S27: NO) and in S29 starts the scanning processes since the restriction setting for the “Scan” function under User B is set to ON in the SFL database 19, i.e., indicates that scanning is not restricted (see FIG. 2).

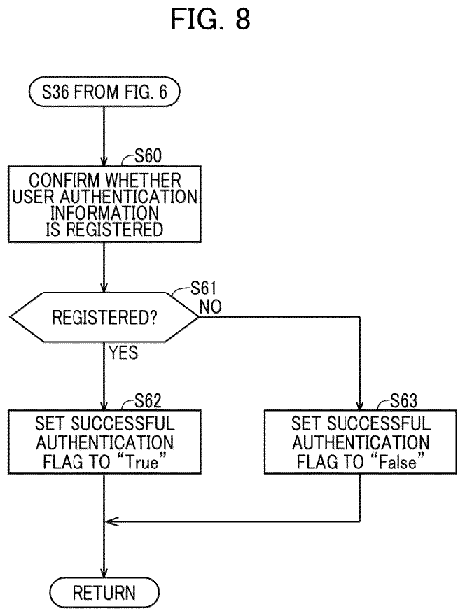

Here, the local login process will be described in this example. User authentication information is recorded in the SFL database 19 for User A and User B. The recorded user authentication information includes a user ID (identifier or identification) and a password associated with the user ID. When a user ID recorded in the SFL database 19 and a password associated with the user ID are inputted via the user interface 16 in the local login process, the controller 11 places the MFP 10 in a locally logged-in state associated with the inputted user authentication information and thereafter performs various processes in the locally logged-in state. For example, when the user ID “User A” and the corresponding password are inputted, the controller 11 places the MFP 10 in a locally logged-in state associated with the inputted “User A” and performs various processes in the locally logged-in state. In other words, user authentication information recorded in the SFL database 19 is authentication information for users permitted to log in to the MFP 10. A locally logged-in state associated with user authentication information may be called a state in which the user specified by the user authentication information is logged in locally. Similarly, the locally logged-in state associated with User A may also be called a state in which User A is logged in locally. Additionally, the user specified by the user authentication information will also be called the “locally logged-in user” or the “local user” when this user is locally logged in to the MFP 10. During the local login process, the user may input the user ID and password by placing an ID card associated with the user ID registered in the SFL database 19 near or in contact with the MFP 10. Information used in the local login process may also be stored in areas of the memory 12 other than the SFL database 19. In this case, the controller 11 may reference this area of the memory 12 in the local login process and the user authentication process of FIG. 8 described later.

Next, the pull scan request process (S12 in FIG. 4) executed by the controller 11 upon receiving an instruction from the PC 40 to execute a pull scan will be described. In the pull scan request process of S12, the controller 11 determines whether to restrict the pull scan or to execute the pull scan without restriction by considering the restriction settings recorded in the SFL database 19 while requesting the authentication information from the PC 4 as needed.

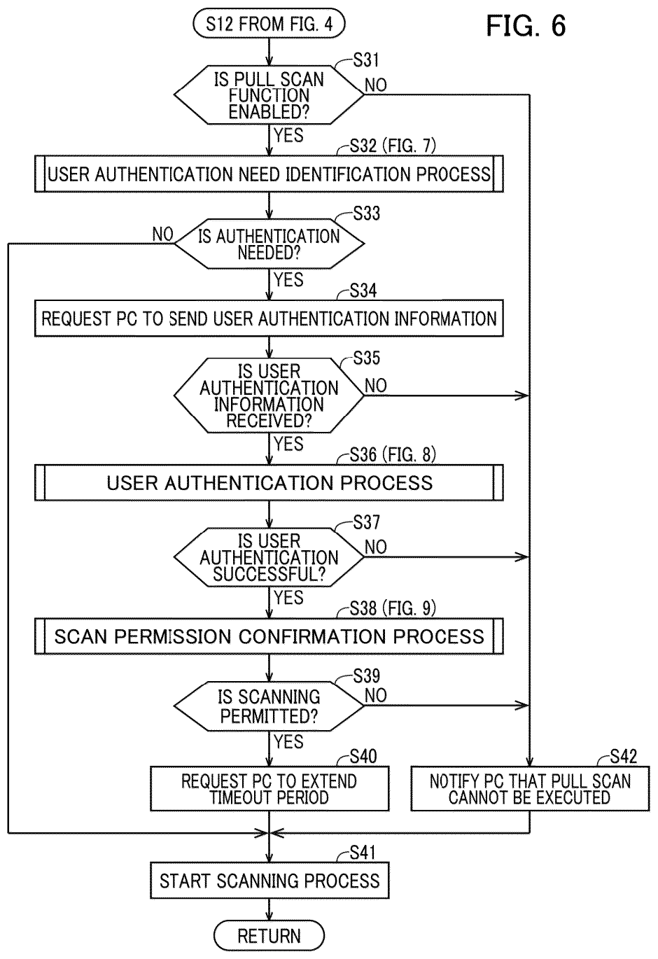

The pull scan request process will first be described for a case in which the MFP 10 is in a locally logged-out state, i.e., when User A operates the PC 40 to execute a pull scan in the public mode. FIG. 6 shows steps in the pull scan request process of S12. In S31 at the start of the process in FIG. 6, the controller 11 determines whether the execution of pull scans has been enabled or disabled on the MFP 10. For example, the controller 11 may make this determination based on information stored in the memory 12 separate from the SFL database 19 indicating whether the pull scan function is set to “enabled” or “disabled.” This example will assume that the pull scan setting is enabled (S31: YES). In this case, the controller 11 executes a user authentication need identification process in S32. In this process, the controller 11 references the restriction setting for push scans under the “Public Mode” to identify whether user authentication is required for a pull scan execution instruction. Here, when the push scan is disabled in the restriction setting for the “Public Mode”, the controller 11 determines that the pull scan is also disabled. Note that when the pull scan setting is “disabled” for the MFP 10 (S31: NO), in S42 the controller 11 notifies the PC 40 that a pull scan cannot be executed. In other words, when the pull scan function is disabled on the MFP 10, the controller 11 cannot execute a pull scan regardless of who is locally logged in to the MFP 10.

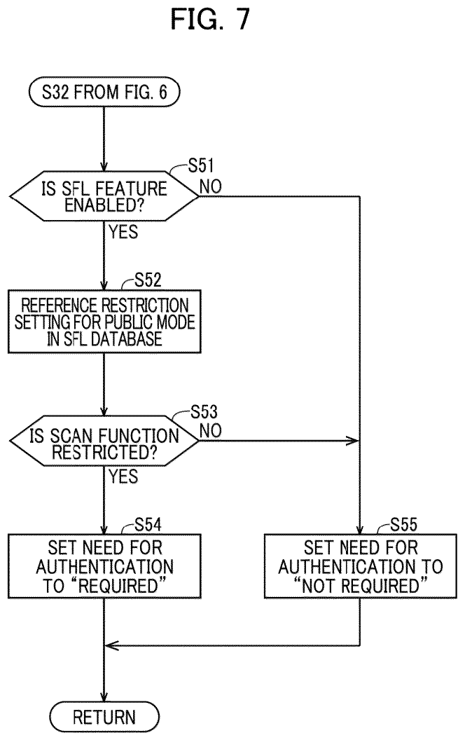

FIG. 7 shows steps in the user authentication need identification process of S32. In this process of S32, the controller 11 determines whether the user authentication is required. In S51 at the beginning of the process in FIG. 7, the controller 11 references the SFL feature information in the SFL database 19 to determine whether the SFL feature has been enabled. Since this example assumes that the SFL feature information recorded in the SFL database 19 specifies “enabled” (S51: YES), in S52 the controller 11 references the SFL database 19 to obtain the restriction setting for the “Scan” function under “Public Mode” (see FIG. 2). In S53 the controller 11 determines whether the restriction setting referenced in S52 indicates that push scans are restricted in the logged-out state.

Since the “Scan” function under “Public Mode” in the example of FIG. 2 is unchecked, indicating that scanning (the pull scan) is restricted (S53: YES), in S54 the controller 11 establishes that user authentication is required for pull scan execution instructions. For example, the controller 11 sets a need determination flag to a value indicating that user authentication is required. Subsequently, the controller 11 ends the process in FIG. 7 and returns to FIG. 6.

In S33 the controller 11 confirms whether user authentication is required. In this example, since the need determination flag was set in S54 to a value indicating that user authentication is required (S33: YES), in S34 the controller 11 communicates with the PC 40 (e.g., sends an HTTPS GET request) to request user authentication information necessary for authenticating the user. Upon receiving a request for user authentication information from the MFP 10, the PC 40 transmits response data to the MFP 10 including user authentication information for the user operating the PC 40, for example. Specifically, the user authentication information includes a user ID and password. This user authentication information externally (or remotely) received in S34 is an example of the user authentication information received in association with the pull scan execution instruction. In this example, the PC 40 transmits response data that includes user authentication information for User A, but the PC 40 may send response data that includes user authentication information for the user currently logged in to the PC 40. Alternatively, the PC 40 may send response data that includes the user authentication information inputted by the user when logging in to the PC 40. The PC 40 may also prompt the user to input the user ID and password after receiving this GET request and may send the inputted user ID and password as response data. Note that the user authentication information is received externally (remotely) from the PC 40 as a response to the request transmitted in S34, but is not received locally (directly) using the user interface 16, in this example. The user authentication information may be previously received concurrently with the pull execution instruction that is subject of the determination in S1. When the user authentication information is previously received concurrently with the pull execution instruction, the controller 11 may omit the process S34 and reference the previously received user authentication to perform a determination of S35 described below. The user authentication information received in association with the pull scan execution instruction may be the user authentication information to determine whether to start the pull scan based on the pull scan execution instruction. The user authentication information received in association with the pull scan execution instruction may be referred as the user authentication information received together with the pull scan execution instruction.

The controller 11 will be unable to execute a user authentication process described later in S36 when the PC 40 does not send user authentication information in response to the GET request received from the MFP 10. Therefore, in S35 the controller 11 determines whether user authentication information was received from the PC 40 and, when user authentication was not received (S35: NO), in S42 the controller 11 notifies the PC 40 that the pull scan cannot be executed.

Assuming that user authentication information was received from the PC 40 in this example (S35: YES), the controller 11 executes the user authentication process of S36. FIG. 8 shows steps in this user authentication process. In S60 at the beginning of the process in FIG. 8, the controller 11 confirms whether the user authentication information received from the PC 40 (information indicating User A in this example) is registered in the SFL database 19 as information for use in the login process. As shown in FIG. 2, information specifying users that can log in to the MFP 10, i.e., user authentication information for at least User A and User B, has been registered in the SFL database 19. In S61 the controller 11 determines whether the user authentication information, i.e., the user ID and password, received from the PC 40 are registered in the SFL database 19. Since the user authentication information is registered in the SFL database 19 in this case (S61: YES), in S62 the controller 11 establishes that user authentication was successful. Because this user authentication is executed using the user authentication information remotely or externally received from the MFP 10, the user authentication may be referred to as the remote (or external) user authentication. For example, the controller 11 sets an authentication flag (successful authentication flag) specifying whether remote (external) user authentication was successful to a value indicating remote (external) user authentication succeeded (true). On the other hand, when the user authentication information received from the PC 40 is not registered in the SFL database 19 (S61: NO), in S63 the controller 11 sets the authentication flag to a value indicating that remote (external) user authentication failed (false). Subsequently, the controller 11 ends the process in FIG. 8 and returns to FIG. 6. In S37 of FIG. 6, the controller 11 determines whether remote (external) user authentication was successful. When the authentication flag is set to a value indicating that remote (external) authentication failed (false), the controller 11 determines that remote (external) user authentication failed (S37: NO) and executes the process of S42 described above. When the controller 11 performs neither the process of S62 nor the process of S63, the authentication flag is not set a value indicating the user authentication was successful (true). For example, the authentication flag is set to NULL or False when the controller 11 performs neither the process of S62 nor the process of S63.

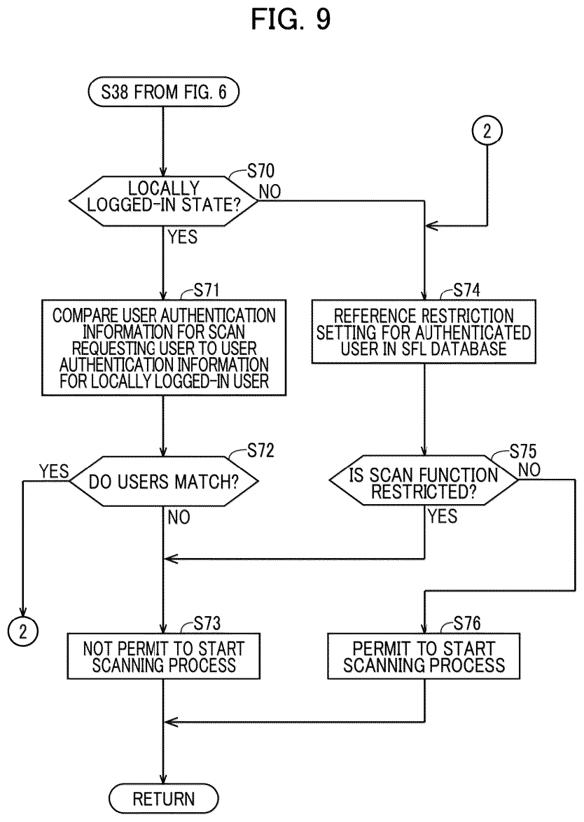

In this example, the controller 11 determines that remote user authentication was successful (S37: YES) and executes a scan permission confirmation process in S38. FIG. 9 shows steps in the scan permission confirmation process. In the scan permission confirmation process, the controller 11 determines whether to permit the pull scan by considering the user that requested the scan execution instruction and/or the restriction setting for the user whose remote user authentication was successful. In S70 at the beginning of the process in FIG. 9, the controller 11 determines whether the MFP 10 is currently in a locally logged-in state, i.e., is not in the public mode. Since the MFP 10 is in the public mode in this example (S70: NO), the controller 11 advances to S74.

In S74 the controller 11 references the restriction setting for the “Scan” function in the SFL database 19 recorded for the user who underwent successful remote user authentication in S36 described above and in S75 determines whether the “Scan” function is restricted for that user in the SFL database 19. In this example, User A was successfully authenticated in S36, and the restriction setting recorded in the SFL database 19 in association with User A for the “Scan” function is “restricted” (see FIG. 2). Therefore, in S75 the controller 11 determines that the “Scan” function is restricted (S75: YES) and in S73 sets a scan permission flag to a value indicating that the MFP 10 is not permitted to start a scan. Subsequently, the controller 11 ends the process in FIG. 9 and returns to FIG. 6.

In S39 of FIG. 6 the controller 11 confirms whether scanning is permitted. Since the scan permission flag has been set to a value indicating that the MFP 10 is not permitted to start scanning, i.e., since the scanning process is not permitted (S39: NO), the controller 11 executes the process of S42 described above. Hence, since push scans are set to “restricted” for User A, the controller 11 restricts pull scans even when remote user authentication was successful in the user authentication process of S36. Subsequently, the controller 11 ends the process of FIG. 6.

Next, the process will be described for a case in which User A is locally logged in to the MFP 10 and operates the PC 40 to execute a pull scan. In this example, the controller 11 still executes the process in S31-S37 of FIG. 6 described above. In S32 of this process, the controller 11 identifies that a push scan is restricted under the Public Mode and in S33 determines that user authentication is required (S33: YES). The controller 11 then executes the process of S38, provided that remote user authentication was successful (S37: YES).

Since the controller 11 determines in S70 of FIG. 9 that User A is in a locally logged in to the MFP 10 (S70: YES), in S71 and S72 the controller 11 determines whether the user requesting the pull scan matches the locally logged-in user. Specifically, in S71 the controller 11 compares the user authentication information used in the user authentication process of S36 described above to the user authentication information of the locally logged-in user and in S72 determines whether the users match. In other words, the controller 11 determines whether the user who operated the PC 40 to request the start of a pull scan matches the user who is locally logged in to the MFP 10. The user who requested the pull scan may also be considered the user indicated by the user authentication information received in association with the instruction to execute the pull scan.

When the controller 11 determines that the users match (S72: YES), in S74 and S75 the controller 11 determines whether the “Scan” function has been set to “restricted” for the user who was successfully authenticated in S36. Since User A is the user successfully authenticated in this example and the “Scan” function is restricted for User A in the SFL database 19 (S75: YES), in S73 the controller 11 does not permit the MFP 10 to start the scanning processes (the pull scan). After returning to FIG. 6, the controller 11 determines in S39 that the scanning process is not permitted, as described above (S39: NO), and executes the process of S42 described above.

In a case where the controller 11 determines in S72 of FIG. 9 that the users do not match (S72: NO), in S73 the controller 11 does not permit the MFP 10 to start the scanning process (the pull scan). Accordingly, in FIG. 6 the controller 11 determines that the scanning process is not permitted (S39: NO) and executes the process of S42.

Next, the process will be described for a case in which the MFP 10 is not in a locally logged-in state (is in the Public Mode) and User B operates the PC 40 to execute a pull scan. In this example, the controller 11 still executes the process in S31-S37 of FIG. 6 described above. In S70 of FIG. 9, the controller 11 determines that the MFP 10 is in the Public Mode (S70: NO). Further, since the user who was successfully authenticated in S36 is User B in this example and the restriction setting for the “Scan” function for User B is “permitted” (S75: NO), in S76 the controller 11 sets the scan permission flag to a value indicating that the MFP 10 is permitted to start scanning processes. After returning to FIG. 6, in S39 the controller 11 determines that the value of the scan permission flag indicates that scanning is permitted (S39: YES). Accordingly, in S41 the controller 11 instructs the scanner 15 to begin scanning, as in S29 (FIG. 5) described above. In other words, since no restriction has been set on pull scans for User B, the controller 11 executes the pull scan on the condition that User B was successfully authenticated in S36. Once the pull scan is started, the scanner 15 accumulates generated data, as part of scan data in the memory 12, and the controller 11 sequentially outputs or sends the part of scan data, accumulated in the memory 12 to the PC 40 that is the transmission destination in order to output the scan data. Before instructing the scanner 15 to begin scanning in S41, in S40 the controller 11 requests the PC 40 to extend a timeout period.

The timeout period is a predetermined length of time that the printer driver of the PC 40 waits while no scan data has been received from the MFP 10 before cancelling communication with the MFP 10. For example, after the printer driver establishes communication with the MFP 10 to perform a pull scan, the printer driver cancels this communication connection in a case where the continuous length of time that the printer driver has been unable to receive scan data (part of scan data) from the MFP 10 becomes longer than the predetermined timeout period or in a case where the transmission of scan data from the MFP 10 has been interrupted and the subsequent continuous length of time that the printer driver is unable to receive scan data becomes longer than the timeout period. The elapsed time for this determination becoming longer than the timeout period may also be referred to as the timeout period elapsing. The length of the timeout period may be 90 seconds, for example.

As will be described later, in a case where the controller 11 starts executing a scan job and subsequently receives a cancellation instruction for cancelling the scan job in progress while the MFP 10 is in a locally logged-out state, the controller 11 performs local user authentication of the user who issued the cancellation instruction. Consequently, the timeout period could elapse while the user is selecting a username and entering a password to execute the cancellation. Here, executing a cancellation will also be referred to as “cancelling a scan job.” Hence, after a YES determination is made in S39 of FIG. 6, the controller 11 requests the PC 40 to extend the timeout period before executing the process of S41, i.e., prior to starting the pull scan.

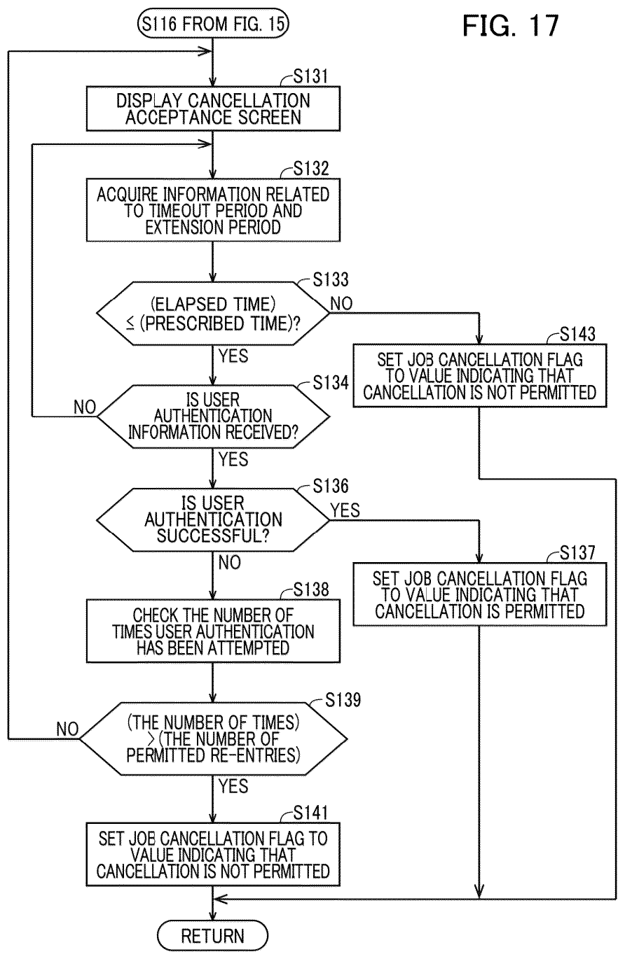

One example of the requested extension period is set to the time required for performing cancellation operations. For example, 30 seconds are required to perform operations when issuing an instruction for one cancellation. The operations involved with issuing a cancellation instruction include inputting a username and password and performing user authentication. There is also a possibility that the user will input the password incorrectly in the cancellation operations. Therefore, the number of times password input errors are allowed (the number of permitted re-entries used in S139 of FIG. 17 described later) during cancellation operations is set to 3. In this case, the requested extension time may be set to a length of time greater than or equal to the time required to perform operations for one cancellation multiplied by the number of permitted password entry attempts (30 seconds*3 times=90 seconds). In S40 the controller 11 transmits information to the PC 40 specifying this 90-second extension and requesting that the timeout period be extended by the extension period, for example.

It is also not necessary that the controller 11 request the PC 40 for an extension to the timeout period. Further, the controller 11 (the MFP 10) may be the entity that determines whether the timeout period has elapsed. In this case, the controller 11 may extend the timeout period.

Next, the process will be described for a case in which User B is locally logged in to the MFP 10 and instructs to perform a pull scan. In this example, the controller 11 executes the process in S31-S37 of FIG. 6 described above. In S70 of FIG. 9, the controller 11 determines that User B is locally logged-in to the MFP 10 (S70: YES). In S71 the controller 11 compares the user that operated the PC 40 to request a pull scan to the locally logged-in user of the MFP 10 and determines in S72 whether the users match. When the users match (S72: YES), in S74 the controller 11 references the restriction setting for the “Scan” function associated with User B and in S75 determines whether “Scan” function is restricted. Since the “Scan” function is permitted in this example (S75: NO), in S76 the controller 11 permits the MFP 10 to start a pull scan. On the other hand, in a case where the controller 11 determines in S72 of FIG. 9 that the users do not match (S72: NO), in S73 the controller 11 does not permit the MFP 10 to start the pull scan. In other words, the controller 11 does not permit pull scans when the user requesting the pull scan does not match the locally logged-in user of the MFP 10, even when the user authentication for User B in this case was successful in S36 and the “Scan” function associated with User B is set to “permitted” in the SFL database 19.

Next, an example of executing a pull scan will be described for a case in which, unlike in the example of FIG. 2, the restriction setting recorded in the SFL database 19 for the “Scan” function under “Public Mode” is set to “permitted,” indicating that the “Scan” function is not restricted with the SFL feature enabled. In this case, when the controller 11 determines in S31 of FIG. 6 that pull scans are enabled (S31: YES), the controller 11 executes the user authentication need identification process of S32. In S51 of the process shown in FIG. 7, the controller 11 determines that the SFL feature is enabled (ON) in the SFL database 19 (S51: YES). In S52 the controller 11 references the restriction setting for the scan function under “Public Mode” and in S53 determines whether the “Scan” function is restricted. Since the restriction setting “permitted” has been recorded in the SFL database 19 for the “Scan” function under “Public Mode” in this example (S53: NO), in S55 the controller 11 sets the need determination flag to a value indicating that remote user authentication is not required for an instruction to execute a pull scan. After returning to FIG. 6, in S33 the controller 11 determines that remote user authentication is not necessary (S33: NO), in S40 requests the PC 40 to extend a timeout period, and in S41 instructs the scanner 15 to begin scanning. In other words, since push scans are not restricted in the Public Mode in this example, the controller 11 does not restrict pull scans to anyone.

Next, an example will be described for a case in which the SFL feature information in the SFL database 19 indicates “disabled” (OFF). When the controller 11 determines in S31 that pull scans are set to “enabled” (S31: YES), the controller 11 executes the process of S32 shown in FIG. 7. In S51 of this process, the controller 11 determines that the SFL feature has been disabled, i.e., is OFF (S51: NO) and executes the process of S55. In other words, since the SFL feature is disabled in this example, the controller 11 does not restrict pull scans for anyone.

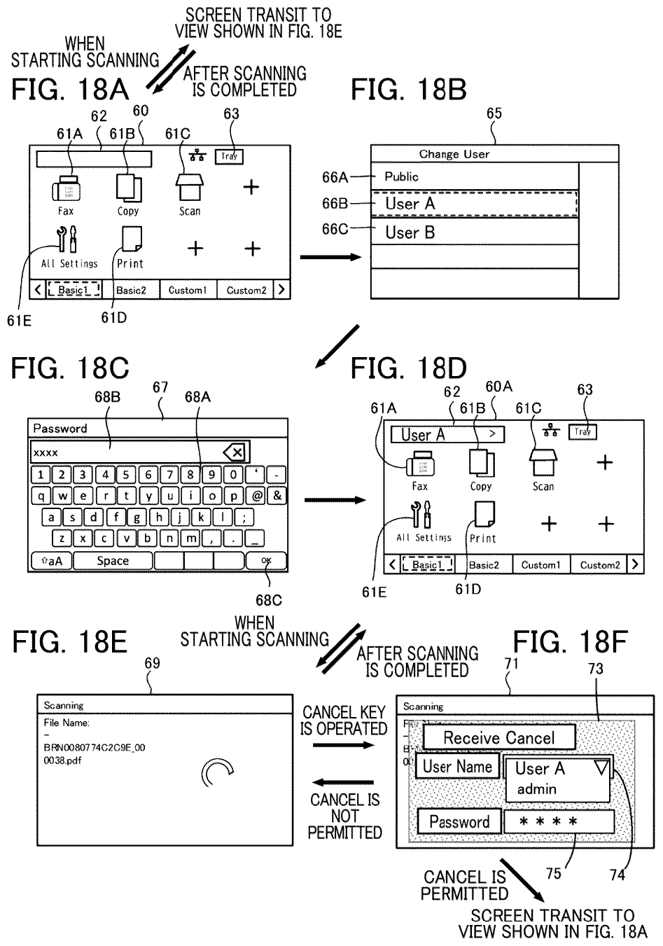

Next, the operational procedure performed and the screens displayed during a scanning process will be described. FIGS. 18A-18E show the transition of screens displayed on the user interface 16 from a standby screen to screens for performing local login operations and initiating a pull scan. As shown in FIG. 18A, the controller 11 displays a standby screen 60 that includes icons 61A-61E for implementing various functions, such as a fax, copy, scan, and print function, and for configuring settings. The standby screen 60 also includes an information field 62 for displaying login information, and a tray icon 63 for selecting the paper tray to be used for printing and other processes.

When the user touches the information field 62, the controller 11 displays a user selection screen 65 shown in FIG. 18B. The user selection screen 65 includes selection icons 66A-66C for selecting different users. The usernames displayed in the selection icons 66A-66C are the usernames registered in the SFL database 19. When the user selects one of the usernames from the selection icons 66A-66C, the controller 11 displays a password entry screen 67 shown in FIG. 18C. However, the controller may not display the password entry screen 67 when the user selects the username “Public” of the selection icon 66A. The password entry screen 67 includes input keys 68A that receive an inputted login password, a password display field 68B for displaying the password inputted via the input keys 68A, and an OK button 68C. When the user inputs a password and touches the OK button 68C, the controller 11 enters a locally logged-in state provided that the username selected in the user selection screen 65 and the password inputted in the password entry screen 67 match data recorded in the SFL database 19.

The screens in FIG. 18A-18E illustrate an example in which User A was selected and local user authentication was successful. In this case, the controller 11 displays the username for the locally logged-in user in the information field 62 of a post-login standby screen 60A, as illustrated in FIG. 18D. When the user touches the information field 62 at this time, for example, the controller 11 displays the user selection screen 65 shown in FIG. 18B so as to receive a local logout operation. That is, when the user then touches the “Public” selection icon 66A, the controller 11 executes a local logout process to shift the locally logged-out state and displays the original standby screen 60 shown in FIG. 18A.

The controller 11 can also accept an operation to change the locally logged-in user through the user selection screen 65 of FIG. 18B. For example, the controller 11 displays the user selection screen 65 when the user touches the information field 62 in the post-login standby screen 60A of FIG. 18D. When the user subsequently touches the “User A” selection icon 66B or the “User B” selection icon 66C, the controller 11 may display the password entry screen 67 shown in FIG. 18C to accept an inputted login password and may shift to a locally logged-in state when the inputted password matches data registered in the SFL database 19 for the selected user. Thus, even when the MFP 10 is in a locally logged-in state, the controller 11 may accept login operations from a separate user to change the user that is locally logged in to the MFP 10. The controller 11 may also be configured to display the username of the locally logged-in user at the position of and in place of the tray icon 63 in the post-login standby screen 60A. The controller 11 may then accept a local logout operation when the user touches the locally logged-in username. The controller 11 may also execute a local logout process without displaying the user selection screen 65 shown in FIG. 18B when the user touches the information field 62 in the standby screen 60A of FIG. 18D.

The controller 11 receives an instruction to execute a push scan in a case where the MFP 10 is in a locally logged-out state and a user operates the Scan icon 61C displayed in the standby screen 60 (see FIG. 18A) or in a case where the MFP 10 is in a locally logged-in state and a user operates the Scan icon 61C in the standby screen 60A (see FIG. 18D). When the controller 11 receives an instruction to execute a push scan (S1: YES) and determines that the push scan can be executed in the push scan request process (S11 in FIG. 4), the controller 11 initiates the scanning process (S29 shown in FIG. 5). At this time, the controller 11 displays a scan-in-progress screen 69 shown in FIG. 18E. Alternatively, when the controller 11 receives an instruction from the PC 40 to execute a pull scan (S1: YES) and determines in the pull scan request process that the scan can be executed (S12 shown in FIG. 4), the controller 11 initiates the scanning process (S41 shown in FIG. 6) and displays the scan-in-progress screen 69 shown in FIG. 18E.

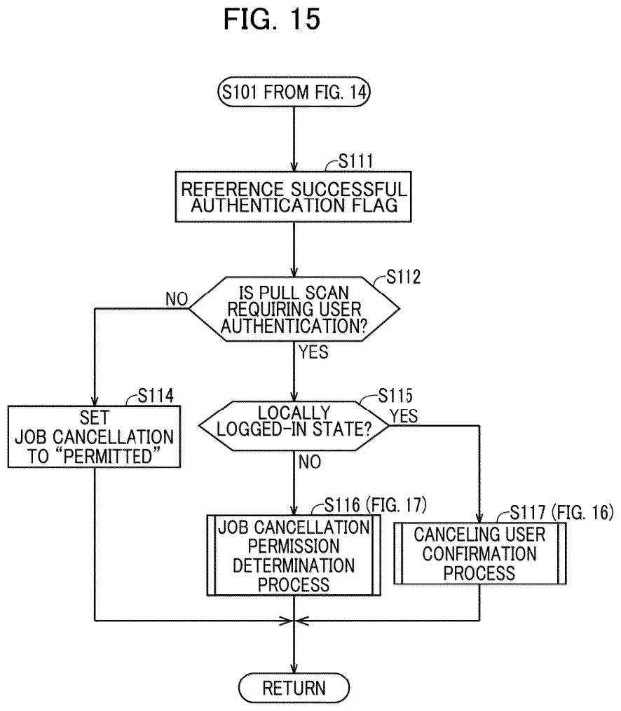

As shown in FIG. 18F, the controller 11 displays a cancellation acceptance screen 71 in place of the scan-in-progress screen 69 on the touch screen of the user interface 16 in a case where a prescribed condition (FIG. 15 described later) is met while the scan-in-progress screen 69 is displayed on the touch screen of the user interface 16. As shown in FIGS. 18E, the controller 11 includes information on a file name to be created in the scan-in-progress screen 69. As shown in FIG. 18F the controller 11 includes a cancellation acceptance area 73 in the cancellation acceptance screen 71. The cancellation acceptance area 73 is an area for receiving user authentication information. However, as shown in FIG. 18E, the controller 11 does not include the information field 62 for performing a local logout operation in the scan-in-progress screen 69. As shown in FIG. 18F, the controller 11 also does not include the information field 62 in the cancellation acceptance screen 71.

Returning to FIG. 3, in S3 the controller 11 determines whether the scanning process was completed. That is, in S3 the controller 11 determines whether the scanning process is inactive. In other words, the controller 11 determines whether the controller 11 is free from the scanning process (or determines whether the controller 11 is out of execution of the scanning process). In a case where the scanning process was completed, i.e., the scanning process is inactive (S3: YES), the controller 11 redisplays the standby screen 60A shown in FIG. 18D when in a locally logged-in state and redisplays the standby screen 60 shown in FIG. 18A when in a locally logged-out state. As described above, when the controller 11 initiates a scanning process in a locally logged-in state, the controller 11 continues to display the scan-in-progress screen 69 on the user interface 16 while preventing the user from executing a local logout operation or an operation to change the locally logged-in user, until the scanning process is completed (S3: YES) or a cancel operation described later is performed (S8 shown in FIG. 3: YES).

Note that the method of preventing the user from performing a local logout operation or an operation to change the locally logged-in user during a scanning process is not limited to the method of displaying the scan-in-progress screen 69. For example, the controller 11 may continue to display the standby screen 60 or 60A with the information field 62 after initiating a scanning process while simply disabling operations on the information field 62. Alternatively, the controller 11 may be configured to accept a local logout operation or an operation to change the locally logged-in user through the user interface 16 from the start of the scanning process to the end of the process or until the process is canceled (i.e., while the scan is in progress).

Next, a process performed by the controller 11 to accept an instruction to cancel a job generated in response to a scan execution instruction received from a user (hereinafter also called a “scan job”) will be described. To avoid making the description too complicated, the following description will cover a case in which only one scan job was generated. However, the process for determining whether to allow a plurality of jobs to be canceled when the plurality of scan jobs has been generated is similar to the cancellation process described below for a single scan job.

As shown in FIG. 3, after executing the scan request process of S2, in S3 the controller 11 determines whether the scanning process is inactive. Here, the controller 11 determines that the scanning process is inactive in a case where the scanning process has been completed or in a case where no scanning process has been started. Specifically, the controller 11 determines whether a push scan started in S29 (FIG. 5) or a pull scan started in S41 (FIG. 6) was completed and whether no scanning process was started. When either a push scan or a pull scan initiated in the scan request process of S2 was completed, i.e., when all scan data has been completely generated and outputted, the controller 11 makes YES determination in S3 and ends the process of FIG. 3. Further, when neither a push scan nor a pull scan was started in the scan request process of S2, i.e., when the controller 11 execute neither the process of S29 (FIG. 5) nor the process of S41 (FIG. 6), the scanning process is inactive and thus the controller 11 makes YES determination in S3 and ends the process in FIG. 3. However, when either a push scan started in S29 or a pull scan started in S41 is still in progress (S3: NO), i.e., when not all scan data has been completely generated and outputted, the scanning process is active (not inactive), the controller 11 makes NO determination in S3 and in S4 the controller 11 executes an error monitoring process.

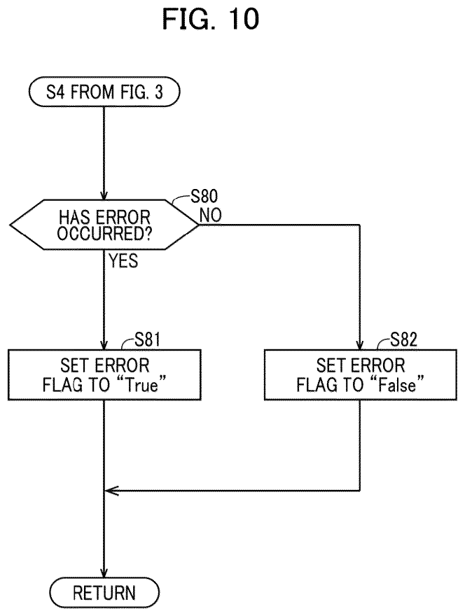

FIG. 10 shows steps in the error monitoring process of S4. In S80 at the beginning of the process in FIG. 10, the controller 11 determines whether an error has occurred on the MFP 10. Examples of errors that the controller 11 monitors in S80 are errors in which other processes may be affected by the continuation of the scanning process, and errors that make it difficult to continue the scanning process. As a specific example, the controller 11 monitors whether the memory 12 has insufficient memory available (hereinafter also referred to as being “out of memory” or having a “full memory”). As will be described later, the controller 11 continues generating scan data based on the current scan job until an instruction to cancel the scan job is received in S5. When generated part of the scan data is accumulated in the memory 12 until a decision is made regarding whether to allow execution of the cancel operation, the work area of the memory 12 may become insufficient or the memory 12 may become full, depending on the volume of scan data and the storage capacity of the memory 12. In a case where the controller 11 temporarily halts the output of scan data in response to receiving a cancellation instruction but continues to generate and accumulate scan data in the memory 12, the possibility of the memory becoming full is even greater. When the memory becomes full, the capacity of work areas for other processes may become insufficient, causing delays or other problems with the execution of the other processes. Therefore, when the memory becomes full, the controller 11 determines in S80 that an error has occurred (S80: YES). In S81 the controller 11 sets an error flag specifying whether an error has occurred to a value indicating that an error has occurred (true). When the controller 11 determines in S80 that an error has not occurred (S80: NO), in S82 the controller 11 sets the error flag to a value indicating that an error has not occurred (false).

The error being monitored in S80 is not limited to the “out of memory” error described above. For example, when the MFP 10 is provided with an ADF (Automatic Document Feeder), the controller 11 may determine that an error has occurred in a case where sheets of the original being scanned become jammed in the ADF during conveyance. In such a case, the scanning process is difficult to continue. Alternatively, when an error has occurred in the image sensor during a reading operation of a document, the controller 11 may determine that an error has occurred since the scanning process is similarly difficult to continue.

After executing the process of S4 in FIG. 3, in S5 the controller 11 determines whether an instruction to cancel a scan job (hereinafter referred to as a “cancellation instruction”) was received. Methods in which a user can issue a cancellation instruction for a scan job include performing an operation on the user interface 16 of the MFP 10 (hereinafter called a cancellation instruction through a user interface operation) and performing an operation on the PC 40 (hereinafter called a cancellation instruction through a PC operation). In other words, the cancellation instruction through a user interface operation is a cancellation instruction issued locally (directly), whereas the cancellation instruction through the PC operation is a cancellation instruction issued remotely (externally). The cancellation instruction through a user interface operation involves operating a key provided separately from the touchscreen, such as a Cancel key. A cancellation instruction through a user interface operation may also be achieved through an operation on a software key displayed on the touchscreen. When a cancellation instruction was not received (S5: NO), the controller 11 returns to S3. In this case, the controller 11 advances to S4 while a push scan or a pull scan is still in progress (S3: NO), i.e., while the output of generated scan data is not complete, as described above.

When the controller 11 receives a cancellation instruction (S5: YES), in S6 the controller 11 executes a job cancellation request process. Here, the controller 11 may temporarily halt the output of scan data upon receiving a cancellation instruction in S5. For example, the controller 11 may temporarily halt reading the document with the scanner 15 and generating scan data. The controller 11 may temporarily save the generated part of the scan data, that is, the scan data generated to this point. Alternatively, the controller 11 may temporarily stop outputting scan data (generated part of scan data) while continuing to read the document with the scanner 15 and to generate scan data. In this case, the controller 11 may temporarily save the generated scan data (the generated part of scan data) in the memory 12.

When YES determination is made in S5, the controller 11 may stop outputting scan data and discard the scan data generated to this point. In this case, when a cancellation of the scan job is not executed as described later, the controller 11 may restart reading the document from the beginning.

Moreover, the controller 11 need not halt the output, generation, and/or the like of scan data for any type of scanning processes. For example, the controller 11 may temporarily halt the output of scan data when starting the job cancellation permission process of FIG. 15 described later. In other words, the controller 11 may halt the output of scan data when determining whether to permit the execution of a cancel operation beginning from S101 (described later), but only when a pull scan is the subject of the scan job cancellation. Specifically, the controller 11 may temporarily halt the output of scan data for a pull scan job that is the subject of the determination as to whether to permit cancellation based on whether the pull scan execution instruction was received in association with user authentication information (S112) or whether the MFP 10 is in a locally logged-in state (S115), as will be described later.

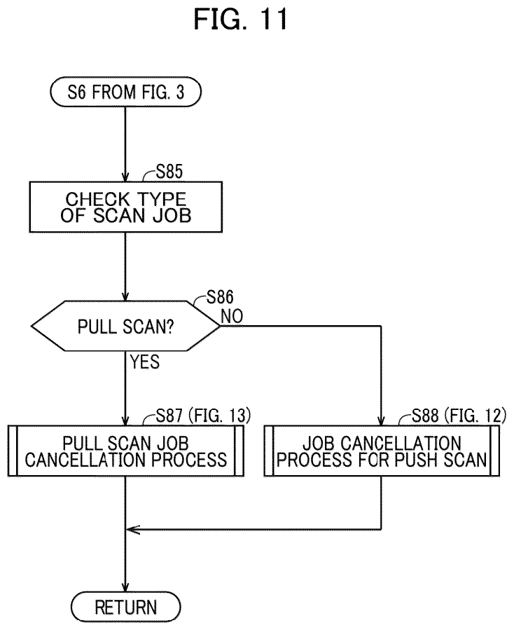

FIG. 11 shows steps in the job cancellation request process of S6. In the job cancellation request process of S6, in a case where the cancellation instruction is an instruction to cancel the pull scan, the controller 11 determines whether to permit cancelling the pull scan before cancelling. On the other hand, in a case where the cancellation instruction is an instruction to cancel the push scan, the controller 11 cancels the push scan according to the cancellation instruction without determining whether to permit cancelling the push scan.

Specifically, in S85 at the beginning of the process in FIG. 11, the controller 11 checks the type of the scan job. First, this process will be described for a case in which the controller 11 received a cancellation instruction after starting a push scan. In S86 the controller 11 determines whether the type of scan job is a pull scan. In this example, the controller 11 determines that the scan job is not a pull scan but is a push scan (S86: NO) and executes a cancellation process in S88 for cancelling the scan job in progress (the job of the push scan in this case). When the controller 11 determines that the type of scan job confirmed in S85 is a pull scan (S86: YES), the controller 11 executes a pull scan job cancellation process of S87 described later.

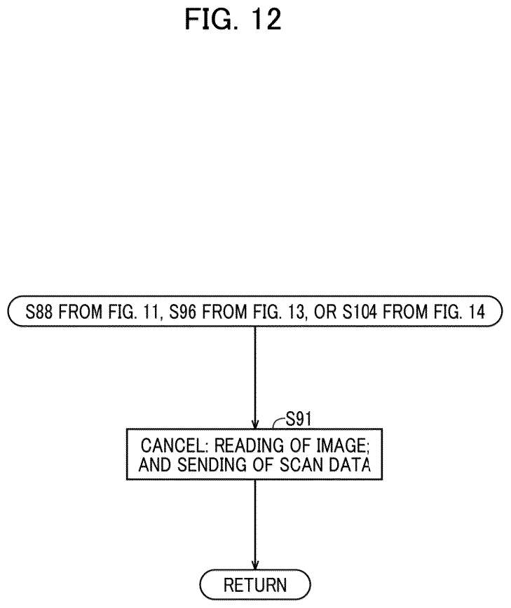

FIG. 12 shows steps in the job cancellation process of S88 for cancelling a scan job in progress. In S91, the controller 11 cancels a scan job for a scanning process in progress (the push scan in this example). Here, the controller 11 completely ends any temporarily halted processes for outputting scan data and the like and discards any generated scan data. After completing the process of S91, the controller 11 ends the process of S6 in FIG. 11 and returns to FIG. 3. After executing the process in S6 of FIG. 3, in S8 the controller 11 determines whether the scan job was canceled, i.e., whether the process in S91 of FIG. 12 was executed. When the scan job was canceled (S8: YES), the controller 11 ends the process in FIG. 3. In this case, the controller 11 stops displaying the scan-in-progress screen 69 shown in FIG. 18E and re-displays the standby screen 60A in FIG. 18D when in a locally logged-in state or the standby screen 60 in FIG. 18A when in a locally logged-out state. Note that the controller 11 may execute the process in FIGS. 11 and 12 without temporarily halting the scan job (the outputting of scan data and the like) after reaching a YES determination in S5.

Hence, in the case of push scans, the controller 11 cancels the scan in response to a cancellation instruction, regardless of whether the cancellation instruction was received through a user interface operation or a PC operation. As described above, the user must operate the user interface 16 of the MFP 10 to instruct the MFP 10 to begin a push scan. Therefore, when the cancellation instruction is received through a user interface operation, it is highly likely that the user instructing the push scan in front of the user interface 16 also operated the user interface 16 to issue the cancellation instruction. Moreover, for the push scan, there is essentially no means for accepting an instruction to cancel a scan job other than the device associated with that scan job. Specifically, there is no means for receiving an instruction to cancel a scan job other than the device that accepts the instruction to start scanning and the device that performs the scan job in response to this instruction. In other words, a cancellation instruction is essentially not issued from another device not involved in the execution of the scan job for the push scan. In the case of a push scan, the MFP 10 is both the device that receives the instruction to start scanning and the device that executes the scan job. Therefore, it is appropriate to provide only the MFP 10 with means for accepting cancellation instructions for scan jobs of push scans. Hence, when the MFP 10 receives a cancellation instruction for a push scan, the MFP 10 cancels this scan job without going through a job cancellation permission process described later (see FIG. 15), regardless of whether or not the MFP 10 is in a locally logged-in state.

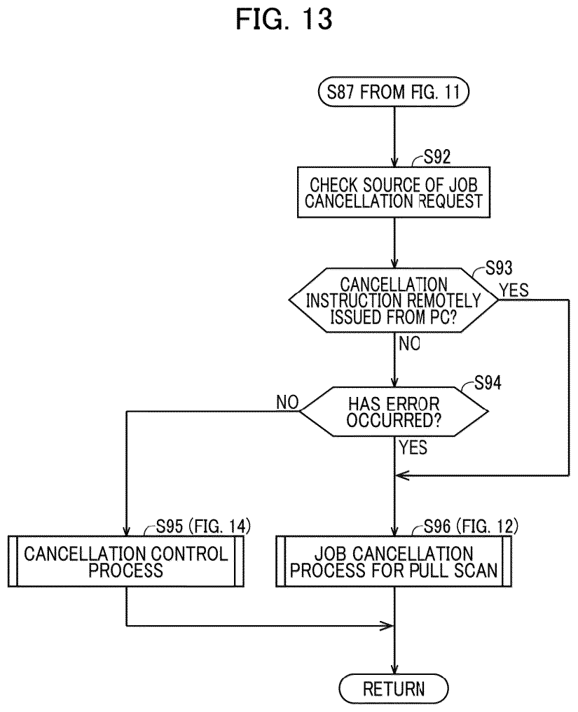

Next, the process will be described for a case in which a cancellation instruction is issued through a PC operation after a pull scan was started. In this case, the controller 11 determines in S86 of FIG. 11 that the scan job is a pull scan (S86: YES) and in S87 executes the pull scan job cancellation process shown in FIG. 13. In S92 of FIG. 13 at the beginning of the process in FIG. 13, the controller 11 checks the source of the job cancellation request, i.e., how the cancellation instruction was issued, and in S93 determines whether the cancellation instruction was issued through a PC operation. When the cancellation instruction was issued through the user interface operation using the user interface 16 and not a PC operation (S93: NO), the controller 11 advances to S94.

However, since the cancellation instruction was issued through a PC operation in this example (S93: YES), in S96 the controller 11 executes the job cancellation process of FIG. 12 described above. In the case of a pull scan, the PC 40 is the device that receives the user instruction to start the scan. Accordingly, with pull scans in the present embodiment, the PC 40 that receives the user instruction to start the scan is the only device other than the MFP 10 from which the MFP 10 receives a cancellation instruction for the scan job initiated by that start instruction. Therefore, when the MFP 10 is executing a pull scan, a cancellation instruction through a PC operation can only be sent from the same PC 40 (external device) that initiated the scan. That is, the MFP 10 only accepts a cancellation instruction when the cancellation instruction has been transmitted from a device (the PC 40) that has initiated the pull scan (that has transmitted the execution instruction of the pull scan). In other words, when any user starts a pull scan through an instruction on the PC 40, a different user operating a different PC cannot cancel the pull scan. Therefore, even when a cancellation instruction is issued through a PC operation, it is highly likely that the user who issued the instruction to start the pull scan also issued the cancellation instruction from the same PC 40. Accordingly, in S91 of FIG. 12 the controller 11 cancels the scan job for the pull scan without going through the job cancellation permission process described later (see FIG. 15), when the cancellation instruction was issued through a PC operation.

Next, the process will be described for a case in which an error occurred after a pull scan was started, and a cancellation instruction was issued through a user interface operation. In this case, the controller 11 determines in S5 of FIG. 3 that a cancellation instruction was received (S5: YES), determines in S86 of FIG. 11 that the scan job is a pull scan (S86: YES), determines in S93 of FIG. 13 that the cancellation instruction was not issued through a PC operation (S93: NO), and advances to S94. In S94 the controller 11 determines whether an error has occurred based on the error flag. In a case where an error has not occurred (S94: NO), the controller 11 executes a cancellation control process in S95. However, since an error has occurred in this example, the controller 11 reaches a YES determination in S94 (S94: YES) and advances to S96 to cancel the scan job as described above. Hence, when an error occurs and a cancellation instruction is issued through a user interface operation, in S91 the controller 11 cancels the scan job without going through the job cancellation permission process described later (see FIG. 15), as when the cancellation instruction was issued through a PC operation. Note that the controller 11 may be configured to immediately end the scan job when an event such as a serious error requiring the immediate termination of the scan job occurs.

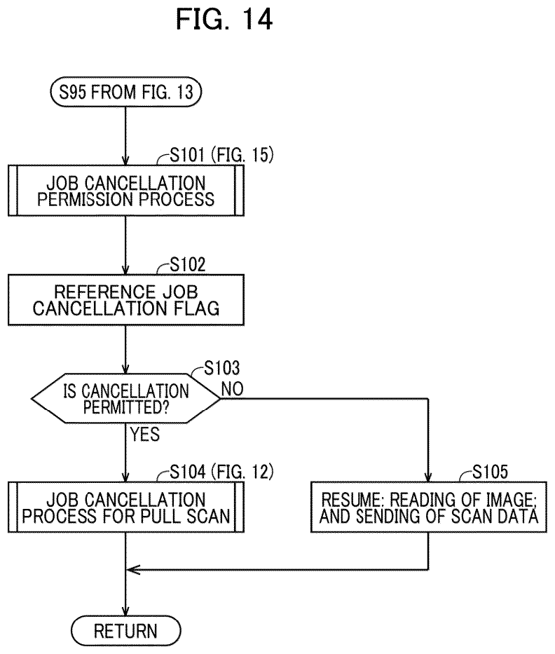

Next, the process will be described for a case in which a cancellation instruction was issued through a user interface operation using the user interface 16 after a pull scan was started, without an error occurring. In this case, the controller 11 determines in S86 of FIG. 11 that the scan job is a pull scan (S86: YES), determines in S93 of FIG. 13 that the cancellation instruction was not issued through a PC operation (S93: NO), determines in S94 that an error has not occurred (S94: NO), and executes the cancellation control process of S95. FIG. 14 shows steps in the cancellation control process of S95. The cancel control process of S95 is a process to determine whether to permit cancelling the pull scan, and either cancel or does not cancel the pull scan based on the determination. At the beginning of the process in FIG. 14, the controller 11 executes a job cancellation permission process in S101.

FIG. 15 shows steps in this job cancellation permission process of S101. The job cancellation process of S101 is a process to determine whether to permit cancelling the pull scan by considering: a result of authentication; a determination result as to whether the MFP 10 is in a locally logged-in state; a determination result as to whether a locally logged-in user satisfies a predetermined condition; and/or a determination as to whether user authentication is successful information based on user authentication information newly received through the user interface 16. In S111 at the beginning of the process in FIG. 15, the controller 11 references the authentication flag (successful authentication flag) and in S112 determines whether the value of the flag indicates that authentication was successful (true), i.e., whether the scan job in progress is a pull scan job requiring user authentication.

In a case where the SFL feature is disabled (S51 of FIG. 7: NO) or in a case where the SFL feature is enabled (S51: YES) and the “Scan” function under “Public Mode” is not restricted (S53: NO), in S33 of FIG. 6 the controller 11 determines that user authentication is not required (S33: NO). As a result, the controller 11 does not execute the user authentication process of S36 or step S62 or S63 in FIG. 8 for setting the authentication flag. Therefore, in the two cases given above, the authentication flag is not set to a value indicating “success” (true). In such cases, the controller 11 determines in S112 that the current scan job is not a pull scan requiring user authentication (S112: NO). In S114 the controller 11 sets a job cancellation flag to a value indicating that cancellation of the scan job is permitted, and subsequently ends the process in FIG. 15 and returns to the process in FIG. 14. In S102 of FIG. 14 the controller 11 references the job cancellation flag and in S103 determines whether cancellation is permitted. When the job cancellation flag referenced in S102 has a value indicating that cancellation is permitted (S103: YES), in S104 the controller 11 executes the job cancellation process of FIG. 12 described above. Therefore, when the SFL feature is disabled or when the SFL feature is enabled and the “Scan” function is not restricted under “Public Mode,” the user can instruct the MFP 10 to execute a pull scan through an operation on the PC 40 without needing to input user authentication information, and in S91 the controller 11 can cancel the scan job in response to an operation on the user interface 16 without requiring the input of user authentication information.

On the other hand, in a case where the SFL feature is enabled (S51 of FIG. 7: YES), the “Scan” function under “Public Mode” is restricted (S53: YES), and the user authentication information received from the PC 40 is registered in the SFL database 19 so that the user is successfully authenticated (S61 of FIG. 8: YES), in S62 the controller 11 sets the authentication flag to a value indicating “success” (true). In this case, the controller 11 determines in S112 (FIG. 15) that the scan job is a pull scan requiring user authentication (S112: YES) and in S115 determines whether the MFP 10 is in a locally logged-in state. When the MFP 10 is in a locally logged-out state (S115: NO), in S116 the controller 11 performs a job cancellation permission determination process as described later.

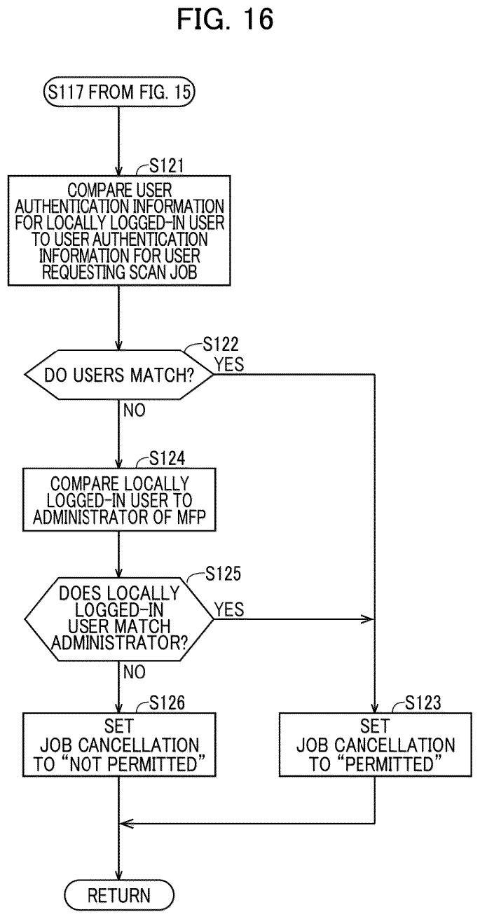

On the other hand, in a case where the controller 11 determines in S115 of FIG. 15 that the MFP 10 is in a locally logged-in state (S115: YES), the controller 11 executes a cancelling user confirmation process in S117. FIG. 16 shows steps in the cancelling user confirmation process of S117. The cancelling user confirmation process of S117 is a process to determine whether the locally logged-in user satisfies the predetermined condition. Here, the predetermined condition includes a condition that the locally logged-in user is the same as the user of the pull scan or an administrator of the MFP 10.

Specifically, in S121 at the beginning of the process in FIG. 16, the controller 11 compares the locally logged-in user to the user who requested the scan job for the pull scan that is now a subject of cancellation. In S122 the controller 11 determines whether the users match. In other words, the controller 11 determines whether the locally logged-in user who issued a cancellation instruction for the scan job via the user interface 16 matches the user whose authentication information was received in association with the instruction to execute the pull scan. When the two users match (S122: YES), in S123 the controller 11 sets the job cancellation flag to a value indicating that cancellation is permitted and ends the process of FIG. 16. Subsequently, in S103 of FIG. 14 the controller 11 determines that the job cancellation flag is set to a value indicating permission (S103: YES) and in S104 executes the job cancellation process of FIG. 12 described above. Therefore, in a case where the MFP 10 is in a locally logged-in state and a cancellation instruction is issued through a user interface operation after a pull scan was started, in S91 the controller 11 cancels the scan job when the locally logged-in user matches the user who issued the execution instruction for the pull scan.

In S121 of FIG. 16 the condition for determining that the locally logged-in user matches the user whose user authentication information was received in association with the instruction to execute the pull scan being canceled is that the usernames of the users are an exact match. However, the condition does not require that the usernames are an exact match. That is, the condition may be that the authentication information of the locally logged-in user corresponds to the authentication information of the user who issued the scan instruction. For example, when their usernames partially match, the controller 11 may determine that the condition is met and thus determine that the users match. Alternatively, rather than matching usernames, when user authentication information essentially indicates the same user, the controller 11 may determine that the condition is met and determine that the users match. For example, in a case where the user authentication information for one user is a user ID while the user authentication information for the other user is a username indicating (or identifying) that user ID, the controller 11 may determine that the users match. In other words, the controller 11 makes a YES determination in S122 when the controller 11 verifies or confirms that the locally logged-in user (or a user account of the locally logged-in user) and the user of the received user authentication information (or a user account of the user of the received user authentication information) are identical. Here, the user account may be an account of the user identified by the user name or the user ID. Further, when the user authentication information includes information specifying a group to which the user belongs, the controller 11 may determine that users match when they belong to the same group.

On the other hand, in a case where the controller 11 determines in S122 that the users do not match (S122: NO), in S124 the controller 11 compares the locally logged-in user to an administrator of the MFP 10 and in S125 determines whether the locally logged-in user and the administrator match. When the two users match (S125: YES), in S123 the controller 11 sets the job cancellation flag to a value indicating that cancellation is permitted and ends the process in FIG. 16. Subsequently, in S103 of FIG. 14 the controller 11 determines that the job cancellation flag is set to a value indicating permission (S103: YES) and in S104 executes the job cancellation process in FIG. 12 described above. Here, the administrator is a user who is authorized to perform various operations on the MFP 10 to manage the MFP 10 that general users are not permitted to perform. Special user authentication information specifying an administrator “Admin” is registered in the SFL database 19, for example. Therefore, when a cancellation instruction is performed through a user interface operation while the MFP 10 is in a locally logged-in state and the locally logged-in user is the administrator, in S91 the controller 11 cancels the scan job, even when the locally logged-in user does not match the user who executed the pull scan.

On the other hand, in a case where the locally logged-in user is not an administrator (S125: NO), in S126 the controller 11 sets the job cancellation flag to a value indicating that cancellation is not permitted and ends the process in FIG. 16. Subsequently, the controller 11 determines in S103 (FIG. 14) that the job cancellation flag is set to a value indicating cancellation is not permitted (S103: NO) and in S105 continues the scan job without cancelling. The controller 11 resumes the outputting of scan data and the like, which was temporarily halted, and subsequently ends the process in FIG. 14, as well as the processes in FIGS. 13 and 11.

After completing the process of S6 in FIG. 3, the controller 11 determines in S8 that the scan job was not canceled (S8: NO). In other words, after executing the process of S105 (FIG. 14), the controller 11 repeats the process from S3 in FIG. 3, and the pull scan job is continued without cancellation. The controller 11 continues the scan job until the scan job is completed (S3: YES) when another cancellation instruction is not received while the scan is in progress. When another cancellation instruction is received (S5: YES), in S6 the controller 11 once again determines whether to permit this cancellation. Further, while the scan has not completed after resuming the process from S3 (S3: NO), the controller 11 executes the error monitoring process of S4 to determine whether an error has occurred. Through the above process, the controller 11 can prevent a pull scan job started after successfully authenticating user authentication information received from the PC 40 from being canceled through operations of a different user from the user who issued the instruction to start the pull scan. Note that the controller 11 need not temporarily halt execution of the scan job when determining that a cancellation instruction was received in S5. In this case, the process of S105 (FIG. 14) may be omitted.

Further, when the controller 11 determines in S115 (FIG. 15) that the MFP 10 is in a locally logged-out state (S115: NO), the controller 11 executes the job cancellation permission determination process in S116, as described above. The job cancellation permission determination process is a process to receive user authentication information for determining whether to permit the cancellation of the pull scan. In this process, the user authentication information can be received while the elapsed time since the output of scan data was halted is no longer than the prescribed time. FIG. 17 shows steps in this job cancellation permission determination process. In S131 at the beginning of the process in FIG. 17, the controller 11 displays a cancellation acceptance screen. That is, when a cancel operation is received via the user interface 16, e.g., a Cancel key, while the scan-in-progress screen 69 shown in FIG. 18E is displayed on the touchscreen of the user interface 16, the controller 11 displays a cancellation acceptance screen 71 shown in FIG. 18F on the touchscreen. The controller 11 then accepts user authentication information through the cancellation acceptance screen 71.

After displaying the cancellation acceptance screen 71 in S131, in S132 the controller 11 acquires information related to the timeout period and sets a prescribed time based on the period specified in this information. Acquiring information related to the timeout period is also referred to as obtaining the timeout period. Further, the period specified by the information related to the timeout period is also simply referred to as the timeout period. The controller 11 acquires the timeout period from the PC 40. In response to a request from the controller 11, the PC 40 adds the extension period requested from the controller 11 in S41 of FIG. 6 to the timeout period set in the printer driver of the PC 40 and sends the result to the MFP 10 as the timeout period. The prescribed time will be described later. The timing at which the controller 11 obtains this timeout period is also not limited to the timing at which S132 is executed. For example, the controller 11 may acquire the timeout period from the PC 40 immediately after requesting the PC 40 to extend the timeout period in S40 of FIG. 6. Alternatively, the controller 11 may obtain the timeout period from the PC 40 when the controller 11 determines that an execution instruction for a pull scan is received from the PC 40 (S10 of FIG. 4: NO). In the latter case, the controller 11 may add the extension period requested of the PC 40 to the acquired timeout period and may set the prescribed time based on the resulting period of time. The information related to the timeout period may include information of the initial timeout period that is the timeout period before extension. Or, the information related to the time out period may include information of an extended timeout period that is a sum of the initial timeout period and the extension time period. Alternatively, the information related to the time out period may include both information of the initial time period and information of the extension time period.

In S133 the controller 11 determines whether the elapsed time since the output of scan data (generated part of scan data) was halted is no longer than the prescribed time. As described above, the controller 11 temporarily halts the output of scan data upon receiving a cancellation instruction in S5 of FIG. 3 (S5: YES). Further, the printer driver of the PC 40 may cancel the communication connection established with the MFP 10 when the printer driver cannot receive any part of scan data from the MFP 10 for a continuous period that exceeds the timeout period. Therefore, when the controller 11 temporarily stops outputting scan data upon receiving a cancellation instruction in S5 (S5: YES), the controller 11 begins measuring the elapsed time. When the elapsed time measured by the controller 11 becomes longer than the prescribed time (S133: NO), in S143 the controller 11 sets the job cancellation flag to a value indicating that cancellation is not permitted, ends the process in FIG. 17, and continues executing the scan job (S103: NO, S105) (FIG. 14). Note that the controller 11 may execute the process of S143 when determining in S133 that the elapsed time is longer than or equal to the prescribed time, as follows, (elapsed time≥prescribed time).

In this embodiment, the printer driver of the PC 40 begins measuring an elapsed time from a starting point when the printer driver could no longer receive scan data from the MFP 10. In a case where the printer driver of the PC 40 receives any amount of scan data from the MFP 10 before the timeout period elapses after that starting point, the controller 11 resets the time measured from the starting point in time, i.e., resets the time measured for determining the timeout period. Therefore, the prescribed time used in S133 may be set to ensure that transmission of scan data performed in S105 after a NO determination is reached (the prescribed time elapses) in S133 can be resumed within the timeout period.

As described above, the controller 11 generates scan data based on the scan job while a cancellation instruction has not been received (S5: NO). Therefore, scan data (or part of scan data) that was generated up until a cancellation instruction was received but not outputted to the PC40 may remain in the memory 12 due to the output of scan data being halted. In such a case, the controller 11 can transmit the scan data stored in the memory 12 immediately after executing the process of S105. In other words, when even a small amount of scan data is stored in the memory 12, the controller 11 can accept a cancellation instruction right up until the timeout period elapses. Hence, a period of time ending just before the timeout period elapses, such as one second before the timeout period elapses, may be used as the prescribed time in S133. Specifically, when the default timeout period is 90 seconds and the controller 11 requested an extension period of 90 seconds, the controller 11 sets the prescribed time to 179 (=180−1) seconds and reaches a YES determination in S133 (S133: YES) until one second before the timeout period elapses. Note that the controller 11 need not determine the elapsed time from the timing at which the output of scan data was halted based on the timeout period. In this case, steps S40 of FIGS. 6 and S132, S133, and S143 of FIG. 17 may be omitted and the controller 11 may execute the process of S134 after S131 to determine whether cancellation is permitted based on user authentication described later.

Further, the controller 11 need not measure the elapsed time to be compared to the prescribed time in S133. For example, the controller 11 may issue a request the PC 40 for the time that has elapsed since the PC 40 could no longer receive scan data. Alternatively, the controller 11 may perform the determination in S133 without using the elapsed time. For example, the controller 11 may query the PC 40 for the remaining time until the timeout period will elapse and may determine in S133 whether the remaining time acquired from the PC 40 is shorter than one second. In this case, the controller 11 executes the process of S143 when the remaining time is less than one second (S133: NO).

Further, the timing at which the controller 11 begins measuring elapsed time is not limited to the timing at which the controller 11 temporarily halts the output of scan data upon reception of a cancellation instruction (S5: YES). For example, the controller 11 may start measuring elapsed time from the timing of S41 at which the controller 11 issued an instruction to the scanner 15 to begin the pull scan and may use this elapsed time as the determination target in S133. Alternatively, the controller 11 may start measuring elapsed time from the timing at which the controller 11 determined that an execution instruction for a pull scan was received from the PC 40 (S10: NO) and may use this elapsed time as the determination target in S133. The controller 11 may also begin measuring the elapsed time from the timing at which the controller 11 received an execution instruction for any type of scan (S1: YES) and may use this elapsed time as the determination target in S133.

When the controller 11 determines that the elapsed time since the output of scan data was halted is no longer than the prescribed time (S133: YES), in S134 the controller 11 determines whether user authentication information was received. As shown in FIG. 18F, the controller 11 displays the cancellation acceptance screen 71 by superimposing a semitransparent cancellation acceptance area 73 over the scan-in-progress screen 69. The cancellation acceptance area 73 includes a user selection field 74, and a password entry field 75.

When the user touches the user selection field 74, for example, the controller 11 displays a pull-down menu showing a list of selectable usernames (or user IDs). The list that the controller 11 displays in the pull-down menu includes only those users who have permission to cancel pull scans among the users registered in the SFL database 19, i.e., the users who can log in to the MFP 10. As described with reference to FIG. 16, a user permitted to cancel a pull scan is the user indicated in the user authentication information received in association with the instruction to execute the pull scan or an administrator, for example. In other words, the controller 11 provides means for issuing a cancellation instruction to the user who requested the pull scan or to an administrator. For example, when User A is the user specified in the user authentication information that was received in association with the instruction to execute the pull scan, the controller 11 displays User A and the administrator (Admin) in the pull-down menu but no other users (e.g., User B), as illustrated in FIG. 18F. However, the method of displaying the list of users in the user selection field 74 is not limited to a pull-down menu.

When the user operates an OK button (not shown) on the user interface 16 after selecting a username in the user selection field 74 and inputting a password into the password entry field 75, the controller 11 determines in S134 that user authentication information was received (S134: YES), and in S136 performs user authentication based on the inputted information. After the controller 11 displays the cancellation acceptance screen 71 and until the OK button on the user interface 16 has been operated, the controller 11 determines in S134 that user authentication information has not been received (S134: NO) and returns to S132 to repeat the above process.

In S136 the controller 11 determines whether the combination of the username selected in the user selection field 74 and the password inputted into the password entry field 75 matches information registered in the SFL database 19. When the information matches registered information, the controller 11 determines that user authentication was successful (S136: YES), in S137 sets the job cancellation flag to a value indicating that cancellation is permitted, and ends the process in FIG. 17.

Thereafter, the controller 11 determines in S103 (FIG. 14) that the job cancellation flag has a value indicating that cancellation is permitted (S103: YES) and in S104 executes the job cancellation process shown in FIG. 12. Specifically, in S91 of FIG. 12, the controller 11 completely ends any temporarily halted processes for outputting scan data and the like and discards any generated scan data. In this way, when the controller 11 receives a cancellation instruction through a user interface operation after initiating a pull scan and the MFP 10 is in a locally logged-out state, the controller 11 performs user authentication. When the user is successfully authenticated, the controller 11 cancels the scan job, provided that the authenticated user requested the pull scan or is an administrator. The controller 11 also terminates the display of the cancellation acceptance screen 71 shown in FIG. 18F and redisplays the standby screen 60 of FIG. 18A for the locally logged-out state.

The controller 11 may include all users registered in the SFL database 19 in the list displayed in the user selection field 74. In this case, when the user authentication in S136 is successful (S136: YES), the controller 11 may execute the cancelling user confirmation process in FIG. 16 to determine whether the user who issued the cancellation instruction is appropriate. Specifically, when the user who issued the cancellation instruction is the user who requested the pull scan (S122: YES) or is an administrator (S125: YES), in S123 the controller 11 sets the job cancellation flag to a value indicating that cancellation of the scan job is permitted, and ends the processes in FIGS. 16 and 17. Subsequently, in S103 (FIG. 14) the controller 11 determines that the job cancellation flag is a value indicating that cancellation is permitted (S103: YES) and in S104 executes the job cancellation process of FIG. 12.

Further, in a case where the controller 11 may execute the cancelling user confirmation process in FIG. 16 after a YES determination is reached in S136 and subsequently the controller 11 sets the job cancellation flag to a value indicating that cancellation of the scan job is not permitted (S126), the controller 11 may return to the process in FIG. 17 and advance to a process described later for checking the number of times user authentication was attempted (S138).

The controller 11 may accept an operation to input a username (or a user ID) in the cancellation acceptance screen 71 in the form of a character string without displaying the list of users. When the user authentication in S136 is successful in this case (S136: YES), the controller 11 may execute the cancelling user confirmation process in FIG. 16 to determine whether the user issuing the cancellation instruction is appropriate.

The controller 11 may also advance to the determination in S136 upon receiving an inputted password in the cancellation acceptance screen 71, without a username (or a user ID) being selected or inputted. In this case, the controller 11 may determine that user authentication is successful (S136: YES) when the password matches the password of an administrator stored in the memory 12 and in S137 may set the job cancellation flag to a value indicating that cancellation of the scan job is permitted.

Further, in a case where user authentication was successful in S136, the controller 11 may place the MFP 10 in a locally logged-in state with the authenticated user as the locally logged-in user after cancelling the pull scan. Once the pull scan has been canceled, the controller 11 may also terminate the display in FIG. 18F, redisplay the standby screen 60A in FIG. 18D, and display the username of the currently locally logged-in user in the information field 62, for example.

Further, when the combination of the username and password is incorrect and user authentication fails (S136: NO), in S138 the controller 11 checks the number of times user authentication has been attempted (the number of attempts). Specifically, in S138 the controller 11 displays the cancellation acceptance screen 71, acquires the number of times user authentication was attempted using inputted user authentication information (i.e., acquires the number of times the process of S136 was executed), and in S139 determines whether the number of attempts is greater than a prescribed number of permitted re-entries. When the number of attempts is less than or equal to the number of permitted re-entries (S139: NO), the controller 11 returns to S131 and displays the cancellation acceptance screen 71 in its initial state after resetting the username selection and the like. Hence, while the number of user authentication attempts is no greater than the number of permitted re-entries (S139: NO) and while the elapsed time is no longer than the prescribed time (S133: YES), the controller 11 repeatedly executes user authentication, which is required for cancelling the pull scan.

When the number of user authentication attempts becomes greater than the number of permitted re-entries (S139: YES), in S141 the controller 11 sets the job cancellation flag to a value indicating that cancellation is not permitted, and subsequently ends the process in FIG. 17. At this time, the controller 11 terminates the display of the cancellation acceptance screen 71 shown in FIG. 18F and redisplays the scan-in-progress screen 69 shown in FIG. 18E. In other words, the controller 11 continues executing the scan job (S103: NO, S105) (FIG. 14) without cancelling the scan job for a pull scan. Therefore, when user authentication for the user associated with a cancellation instruction fails the prescribed number of permitted re-entries, the controller 11 does not cancel the scan job.

As described above, the number of permitted re-entries is the number of times that mistakes are permitted for user selection and password input and is set to 3 in this example. However, the controller 11 does not need to set an upper limit on the number of times the execution of user authentication is allowed. Further, when user authentication fails the prescribed number of permitted re-entries, the controller 11 need not accept a cancellation instruction for the pull scan thereafter. This process can suppress other users from repeatedly attempting user authentication. Further, when the number of user authentication attempts becomes greater than the number of permitted re-entries (S139: YES), the controller 11 may terminate the display of the cancellation acceptance screen 71 shown in FIG. 18F and display the scan-in-progress screen 69 shown in FIG. 18E after displaying a screen indicating that cancellation is not permitted.

Further, when the elapsed time described above becomes longer than the prescribed time (S133: NO) before user authentication has been executed the prescribed number of permitted re-entries, in S143 the controller 11 sets the job cancellation flag to a value indicating that cancellation is not permitted, ends the process in FIG. 17, and continues to execute the scan job (S103: NO, S105) (FIG. 14). Hence, the controller 11 does not permit a pull scan to be canceled when the time remaining until the timeout period elapses becomes short. As described above, a certain amount of operation time is required for performing operations needed for user authentication accompanying cancellation, such as user selection and password entry. Therefore, there is a concern that the timeout period could elapse and the PC 40 could terminate communication before the user has completed user selection and password entry and has operated the OK button (S134: NO). There is also a concern that the timeout period could elapse and the PC 40 could terminate communication while user authentication has failed (S139: NO). Therefore, when the elapsed time becomes greater than the prescribed time, the controller 11 stops accepting cancellation instructions and continues executing the pull scan.

While a scan is in progress, the scan-in-progress screen 69 shown in FIG. 18E or the cancellation acceptance screen 71 shown in FIG. 18F is displayed on the user interface 16. Therefore, in a case where a pull scan is started when the MFP 10 is in a locally logged-out state and after user authentication information sent from the PC 40 has been successfully authenticated, the user cannot perform operations using the standby screen 60 shown in FIG. 18A to locally log in to the MFP 10. Further, when a pull scan is started when the MFP 10 is in a locally logged-in state and after user authentication information sent from the PC 40 was successfully authenticated, the user cannot perform operations using the standby screen 60A shown in FIG. 18D to locally log out or change the locally logged-in user. Displaying the scan-in-progress screen 69 or the cancellation acceptance screen 71 while a pull scan is in progress prevents a different user from the user who initiated the pull scan from changing the MFP 10 to a locally logged-out state or a newly locally logged-in state through the standby screen 60 or the standby screen 60A and operating the MFP 10.

Further, even in a conceivable case where the MFP 10 is placed into a logged-out state or a newly logged-in state through some other method while a pull scan is in progress, the process described using FIGS. 11 through 17 can prevent a pull scan job that was started after user authentication information sent from the PC 40 was successfully authenticated from being canceled by a different user from the user who initiated the pull scan.

The MFP 10 may have a configuration in which a user can locally logs in to the MFP 10 and issues a cancellation instruction through an operation using the user interface 16 before the scan-in-progress screen 69 is displayed upon the start of the pull scan, even when that login user is not an administrator and is different from the user whose user authentication information was remotely received in association with the instruction to execute the pull scan. In such a configuration, the controller 11 makes NO determination in S125 (S125 of FIG. 16: NO), and in S126 the controller 11 still does not permit cancellation.

The MFP 10 may have a configuration in which the controller 11 accepts a local logout operation or an operation to change local users during a scan by displaying the post-login standby screen 60A shown in FIG. 18D rather than the scan-in-progress screen 69 after initiating the pull scan. In such a configuration, the function to cancel the scan job can be disabled in the standby screen 60A, even when a user other than the user whose user authentication information was received in association with the instruction to execute the pull scan locally logs in to the MFP 10 and attempt to issue a cancellation instruction.

The embodiment described above can obtain the following effects. In a case where the controller 11 of the MFP 10 initiates a pull scan, and thereafter receives a cancellation instruction through the user interface 16 to cancel the scan job (S5 of FIG. 3: YES), the controller 11 receives user authentication information through the user interface 16 (S134 of FIG. 17: YES), and cancels the pull scan (S137) when the user authentication information received through the user interface 16 matches the user authentication information received with the instruction to execute the pull scan (S136: YES), but does not cancel the scan job (S141) when the user authentication information does not match. This process ensures that the appropriate user can cancel a scan job by allowing cancellation when the user who instructed execution of a pull scan issues a cancellation instruction for the scan job through the user interface 16 but does not allow cancellation when another user issues a cancellation instruction.

Further, in a case where the controller 11 receives a cancellation instruction after initiating a pull scan while the MFP 10 is not in a locally logged-in state (S115 of FIG. 15: NO), in S116 the controller 11 receives user authentication information to determine whether to cancel the print job. In this way, in a case where the controller 11 receives an execution instruction for a pull scan accompanied by user authentication information while the MFP 10 is in a locally logged-out state, the controller 11 can cancel the pull scan by authenticating the user who issued the execution instruction. Moreover, by performing user authentication, the controller 11 can suppress users other than the user who issued the instruction to execute the pull scan from cancelling the pull scan.

In a case where, after starting a pull scan while the MFP 10 is in a locally logged-out state upon receiving a pull scan execution instruction accompanied by user authentication information (S39: YES, S41) (FIG. 6), the controller 11 receives a cancellation instruction through a user interface operation while the MFP 10 remains in the locally logged-out state (S93 of FIG. 13: NO, S116 of FIG. 15), the controller 11 accepts user authentication information and performs user authentication (S136 of FIG. 17). Thus, in a case where the MFP 10 is in a locally logged-out state when an instruction to execute a pull scan is received, the controller 11 can request user authentication for a cancellation instruction received through a user interface operation for the pull scan while remaining in the locally logged-out state.

In a case where the controller 11 starts a pull scan after confirming the user authentication information for the locally logged-in user corresponds to the user authentication information received in association with the pull scan execution instruction (S72: NO, S76) (FIG. 9), the controller 11 does not accept changes to the locally logged-in user through the user interface 16 by displaying the scan-in-progress screen 69 (FIG. 18E) or the cancellation acceptance screen 71 (FIG. 18F) until the pull scan is completed or canceled. By locally logging in to the MFP 10 in advance, the user can prevent other users from sending an instruction to execute a pull scan and can prevent other users from locally logging in to the MFP 10 until the pull scan that the user initiated is completed or canceled.

In a case where, after starting the pull scan, the controller 11 receives a cancellation instruction through the user interface 16 while the MFP 10 is in a locally logged-in state (S115 of FIG. 15: YES), the controller 11 cancels the pull scan (S123 of FIG. 16) when the user authentication information for the locally logged-in user received earlier through the local login operation matches the user authentication information received in association with the instruction to execute the pull scan (S122: YES), but does not cancel the pull scan (S126) when the user authentication information does not match (S122: NO). In this way, cancellation of a scan job is permitted when the user who issued the instruction to execute the pull scan matches the user currently locally logged in to the MFP 10. For example, when the user moves to the user's PC 40 after having previously locally logged in to the MFP 10 and then executes a pull scan from the PC 40, the user can subsequently cancel the pull scan by operating the Cancel key on the user interface 16.

Further, in a case where the MFP 10 receives user authentication information in response to an instruction to execute a pull scan (S34 of FIG. 6) while the MFP 10 is in a locally logged-in state, the controller 11 starts the pull scan (S76) when the locally logged-in user matches the user of the user authentication information received in association with the execution instruction in S34 (S72 of FIG. 9: YES), and does not start the scan (S73) when the users do not match (S72: NO). In a case where the controller 11 determines that the user authentication information matches and starting the pull scan in the locally logged-in state, and thereafter receives a cancellation instruction through the user interface 16 while the user is still locally logged in, the controller 11 cancels the pull scan when the locally logged-in user matches the user of the authentication information to execute a pull scan received in S34 in the cancellation instruction (S122: YES). In this way, as long as the locally logged-in state is maintained after the user operates the user interface 16 to locally log in with the user's own username prior to executing the pull scan, the user can issue a cancellation instruction through the user interface 16 as needed after starting the pull scan from the PC 40 since the locally logged-in state on the MFP 10 is maintained.

After starting the pull scan in response to determining that the locally logged-in user matches the user indicated by the user authentication information associated with the instruction to execute a pull scan, the controller 11 displays the scan-in-progress screen 69 shown in FIG. 18E or the cancellation acceptance screen 71 shown in FIG. 18F. Therefore, the controller 11 does not accept a local logout operation or an operation to change the user after starting the pull scan until the pull scan is completed or canceled. Since the locally logged-in user cannot be locally logged out or changed, this configuration can prevent a different user other than the user (first user) who issued the execution instruction from locally logging out the first user and locally logging in to issue a cancellation instruction. This also prevents the locally logged-in user from being changed so that the locally logged-in user no longer matches the user of the user authentication information received in association with the execution instruction.

In a case where the controller 11 receives a cancellation instruction through the user interface 16 after starting a push scan (S86 of FIG. 11: NO), the controller 11 cancels the push scan (S91 of FIG. 12) without needing to receive user authentication information through the user interface 16. An instruction to execute a push scan is inputted on the user interface 16. When an instruction to cancel the push scan is subsequently received via the user interface 16, it is highly likely that the user inputting the cancellation instruction is the same user who inputted the execution instruction. Therefore, when an instruction to cancel a push scan is received via the user interface 16, usability can be improved by cancelling the push scan without checking the user's identity through user authentication information.

In a case where the controller 11 receives a cancellation instruction after starting a push scan (S86 of FIG. 11: NO) while the MFP 10 is in a locally logged-out state, the controller 11 cancels the push scan (S91 of FIG. 12) without needing to receive user authentication information through the user interface 16. Because the controller 11 cancels the push scan without verifying identity of the user authentication information, usability can be improved.

In a case where the controller 11 receives a cancellation instruction from the transmission source of a pull scan execution instruction (the PC 40) after starting a pull scan (S93 of FIG. 13: YES), in S96 the controller 11 cancels the pull scan without needing to receive user authentication information via the user interface 16. Once a pull scan has been started, the controller 11 does not accept a cancellation instruction from a device other than the PC 40 that was the source of the pull scan execution instruction. In other words, in a case where a cancellation instruction is received after a pull scan has been started, the controller 11 only accepts the cancellation instruction when the cancellation instruction was issued from the same PC 40 that issued the execution instruction. Hence, in this case usability can be improved by eliminating the need to confirm user authentication information for permitting a cancellation. However, user authentication information may also be checked in this case.

Further, when the SFL feature is disabled (S51 of FIG. 7: NO) or when the SFL feature is enabled (S51: YES) and the “Scan” function is not restricted in the “Public Mode” (S53: NO), the controller 11 starts the pull scan without requiring user authentication information (S33 of FIG. 6: NO). Since step S62 or S63 of FIG. 8 is not executed in this case, the authentication flag is not set to a value indicating “success” (true). Thus, when a cancellation instruction is received through a user interface operation, the controller 11 cancels the pull scan (S114 of FIG. 15) without requiring (considering) user authentication information (S112: NO). This configuration can improve usability by not requiring user authentication to execute a cancel operation when user authentication was not required to execute the pull scan.

The controller 11 cancels a pull scan (S137 of FIG. 17) when the administrator is selected in the user selection field 74 of the cancellation acceptance screen 71 and user authentication is successful (S136: YES). In this way, an administrator can cancel pull scans for any user after undergoing user authentication. Under their authority, administrators can cancel unnecessary scan jobs.

When the controller 11 receives a cancellation instruction but user authentication fails (S136 of FIG. 17: NO), the controller 11 prompts the user to re-enter the user authentication information (S139: NO). In a case where the number of user authentication failures exceeds the prescribed number of permitted re-entries (S139: YES), the controller 11 does not cancel the scan job (S141). This prevents users for whom user authentication has failed a prescribed number of times from cancelling a scan job.

Further, in a case where the elapsed time since the output of scan data was halted becomes greater than a prescribed time based on the timeout period without successful user authentication (S133 of FIG. 17: NO), the controller 11 does not cancel the scan job (S143). This configuration can avoid timing out the connection with the external device that issued the execution instruction for the pull scan. This configuration can also suppress a user from repeatedly issuing cancellation instructions, which can halt the output of pull scan data and delay completion of the pull scan.

In a case where a prescribed time that is shorter than the timeout period for the connection with the PC 40 elapses (S133 FIG. 17: NO) before the controller 11 can successfully authenticate the user (S136: NO), the controller 11 does not cancel the scan job (S143). This configuration can suppress the timeout period from elapsing due to the time required for user selection and password entry, preventing the MFP 10 from becoming disconnected from the PC 40, which is the source of the pull scan instruction.

The controller 11 can also obtain information from the source of the pull scan execution instruction (e.g., the printer driver of the PC 40) related to the timeout period for the connection with the source of the pull scan execution instruction. In a case where a prescribed time shorter than the (extended) timeout period obtained from the PC 40 elapses before the controller 11 can successfully authenticate the user (S133 of FIG. 17: NO), the controller 11 does not cancel the scan job (S143). This configuration enables the controller 11 to obtain, from the PC 40, information related to the timeout period and to determine an appropriate timing to stop accepting a cancellation instruction based on the time indicated by the acquired information related to the timeout period and, hence, can suppress connection timeouts before user authentication is successful.

In S40 of FIG. 6 the controller 11 issues a request to the PC 40 to extend the timeout period. In a case where a prescribed time, which is shorter than the sum of the timeout period and the requested extension time, elapses before the controller 11 can successfully authenticate the user (S133 of FIG. 17: NO), the controller 11 does not cancel the scan job (S143). With this configuration, the controller 11 can request an extension of time needed to complete user authentication for accepting a cancellation instruction when the default timeout period is short. Thus, the controller 11 can allocate sufficient time for accepting user authentication information, thereby ensuring that the user has time to input user authentication information for the cancellation instruction.

As described above, a timeout period is set for a communication connection between the controller 11 and PC 40. When scan data is not transmitted for a period of time that exceeds the time specified by the timeout period, the connection is timed out. In a case where the controller 11 receives a cancellation instruction through a user interface operation after starting a pull scan (S5 of FIG. 3: YES), the controller 11 stores the scan data generated through this scan in the memory 12 and temporarily stops outputting scan data. When user authentication is unsuccessful (S136: NO and S139: YES, or S133: NO) (FIG. 17), the controller 11 transmits the scan data stored in the memory 12 to the PC 40 and continues the pull scan (S105 of FIG. 14). The controller 11 resumes the outputting of scan data and the like, which was temporarily halted. This enables the controller 11 to transmit, from the memory 12 to the PC 40, scan data (part of scan data) that has been generated before the cancellation instruction was received. Thus, the controller 11 can send the scan data (the part of scan data) as quickly as possible after determining that the job will not be canceled, thereby avoiding the connection between the controller 11 and PC 40 from being timed out. On the other hand, when user authentication was successful (S136: YES), the controller 11 discards the scan data stored in the memory 12 (S91 of FIG. 12) and does not send this data to the PC 40. In this way, the controller 11 can avoid sending some of the scan data and the like of a canceled scan job to the PC 40.

When user authentication information is required to execute a pull scan according to a received pull scan execution instruction, reception of the pull scan execution instruction signifies reception of a request to execute a pull scan requiring user authentication based on the user authentication information. When such a request is received and the user authentication information is received and authentication is successful based on the received user authentication information (S37: YES, S39: YES) (FIG. 6), the controller 11 issues a request to the transmission source of the pull scan execution instruction (e.g., the PC 40) to extend the timeout period (S40). In this case, the pull scan requires user authentication to be canceled. Thus, once the controller 11 has determined that a pull scan is to be executed, the controller 11 can request an extension to the timeout period because the pull scan requires user authentication to be canceled. However, the controller 11 may request an extension to the timeout period at a different timing. For example, the controller 11 may request the PC 40 to extend the timeout period when reaching a YES determination in S5 of FIG. 3 for the first time since the process in FIG. 3 was started or when reaching a YES determination in S86 of FIG. 11 for the first time since the process in FIG. 3 was started.

In a case where the controller 11 receives a cancellation instruction through a Cancel key on the user interface 16 while the scan-in-progress screen 69 in FIG. 18E is being displayed, the controller 11 displays the cancellation acceptance screen 71 of FIG. 18F including a list of users who can log in to the MFP 10 in the user selection field 74 and accepts a user selection. When the controller 11 receives a selection of a user as user authentication information (S134: YES), the controller 11 performs user authentication (S136). This process places less burden on the user to input a username than a configuration in which the user directly inputs the username. This configuration also reduces the number of errors that can occur when inputting a username and enables the user to select a username quickly, enabling user authentication to be completed before the timeout period elapses.

The controller 11 also displays a pull-down menu in the user selection field 74 (see FIG. 18F). The pull-down menu includes a list of users (or user IDs or names of the users) who can log in to the MFP 10 (users registered in the SFL database 19, but only those users that have permission to cancel pull scans. When a cancellation instruction is received, the controller 11 accepts a password in the password entry field 75 for the user selected in the user selection field 74 and performs user authentication (S136 of FIG. 17). This method can reliably reduce the occurrence of user selection errors and can speed up user input. As a result, this method can reduce the time required for user authentication, reliably suppressing the occurrence of timeouts.

The controller 11 also determines whether an error has occurred on the MFP 10 (S4 of FIG. 3, S94 of FIG. 13). When the controller 11 determines that an error has occurred (S94: YES) after starting a pull scan (S86 of FIG. 11: YES), the controller 11 cancels the pull scan without requiring user authentication information (S96). This can provide the user with means to quickly terminate a scan job during which an error has occurred. When an error such as an out-of-memory error occurs after a pull scan has been started, the controller 11 can prevent the pull scan from continuing in this error state by cancelling the scan without requiring user authentication. This can prevent the MFP 10 from transmitting scan data with reading errors. In other words, the controller 11 can continue executing a scan job to the extent possible, such as by continuing to send scan data that has been generated, even when an error has occurred, until the user issues a cancellation instruction. In the event of an error, such as a paper jam in the ADF, the user can choose whether to perform an operation to issue a cancellation instruction or to continue the scan job after removing the cause of the error. For example, the user can continue the scan job after clearing a paper jam in the ADF.

### Variations of the Embodiment

In the embodiment described above, the controller 11 requires user authentication for a pull scan when the scan function recorded in the SFL database 19 for the “Public Mode,” i.e., the restriction setting for push scans in a locally logged-out state is “restricted” (S53 of FIG. 7: YES). As a variation, when the restriction setting recorded in the SFL database 19 for the “Scan” function associated with all registered users is “restricted”, the controller 11 may make a YES determination in S53 and require user authentication for a pull scan. When the restriction setting recorded in the SFL database 19 for the “Scan” function is “restricted” for a specific predetermined user, the controller 11 may make a YES determination in S53 and require user authentication for pull scans.

The controller 11 may execute the user authentication process in S36 of FIG. 6 and the scan permission confirmation process in S38 as follows. In this example, within the user authentication process of S36, the controller 11 determines whether the user who operated the PC 40 matches the user locally logged in to the MFP 10 (S70-S72 of FIG. 9). First, in S60 (FIG. 8) of the user authentication process executed in S36, the controller 11 checks whether the user authentication information received from the PC 40 is registered in the memory 12 as an authentication target. When the user authentication information is registered as an authentication target (S61: YES), the controller 11 performs the process of S70 described in FIG. 9, that is, the controller 11 determines whether the user has completed locally logging in to the MFP 10. When the user is already locally logged in to the MFP 10 (S70: YES), as the process of S71 and S72 the controller 11 determines whether the user requesting the pull scan matches the locally logged-in user. When the controller 11 determines that the users match (S72: YES), then subsequently in S62 of FIG. 8 the controller 11 sets a flag indicating that user authentication was successful and advances to S37. Even when the user has not completed locally logging in to the MFP 10 (S70: NO), the controller 11 advances to S62 to set the authentication flag to a value indicating that user authentication was successful, and subsequently advances to S37. However, when the controller 11 determines that the users do not match (S72: NO), in S63 the controller 11 sets the authentication flag to a value indicating that user authentication failed, and subsequently advances to S37.

Subsequently, when the controller 11 determines in S37 of FIG. 6 that user authentication was successful (S37: YES), in S38 the controller 11 performs the scan permission confirmation process. In the scan permission confirmation process of S38, the controller 11 does not execute the process in S70-S72 described in the embodiment since this process has already been executed in the user authentication process of S36. Specifically, in S74 the controller 11 references the restriction setting for the “Scan” function corresponding to the user whose authentication was successful. When the restriction setting “restricted” has been recorded in the SFL database 19 for the “Scan” function corresponding to this user (S75: YES), the controller 11 advances to S73 and does not permit the scan process (pull scan) to begin. However, when the restriction setting “restricted” is not recorded in the SFL database 19 for the “Scan” function associated with this user (S75: NO), the controller 11 advances to S76 to permit the pull scan to begin.

### OTHER EMBODIMENTS

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

The order, contents, and the like of the processes shown in FIGS. 3 through 17 of the above embodiment are merely examples. In the embodiment described above, the controller 11 checks the registration of the user requesting a pull scan in S36 of FIG. 6 (S61 of FIG. 8), determines whether this registered user matches the locally logged-in user in S71 and S72 of FIG. 9, and permits the pull scan to be executed when the users match (S72: YES). However, the controller 11 may simply check the registration of the user in S36 (S61) without determining in S71 and S72 whether the registered user matches the logged-in user. That is, the controller 11 may permit the pull scan to be executed when the user requesting the pull scan is registered (S37: YES), regardless of whether the registered user matches the locally logged-in user. In this case, the controller 11 may accept an instruction to execute a pull scan when the SFL feature is disabled or when the SFL feature is enabled and the MFP 10 is in the public mode and may permit the pull scan to be executed when the username received in association with the execution instruction is registered in the SFL database 19.

Further, in a case where the controller 11 initiates a push scan while in a locally logged-in state and thereafter the controller 11 receives a cancellation instruction while still in the locally logged-in state, the controller 11 may prompt the locally logged-in user to re-input the user's password and may cancel the push scan when the inputted password matches the password entered for the locally logged-in user. In this case, the controller 11 may require the locally logged-in user to re-input the user's password by using the user interface 16.

The controller 11 may not determine whether the user issued the cancellation instruction is the administrator.

The controller 11 may not request the PC 40 to extend the timeout period.

The controller 11 may also be configured not to execute processes for determining whether an error has occurred on the MFP 10, such as the process of S4 described in FIG. 10 and the process of S94 in FIG. 13. In this case, the controller 11 continues to determine whether a cancellation instruction was received in S5 of FIG. 3 while reaching a NO determination in S3 (S3: NO). Further, the controller 11 executes the cancellation control process of S95 in FIG. 13 when reaching a NO determination in S93 (S93: NO), i.e., when a cancellation instruction was received through a user interface operation.

The controller 11 may also accept a local login operation by an administrator while the scan-in-progress screen 69 is displayed when a prescribed operation is received through the user interface 16. This allows an administrator to locally log in and cancel a scan operation in progress while displaying the scan-in-progress screen 69.

In the embodiment described above, the controller 11 uses the SFL database 19 to authenticate a username (or a user ID) and password and to restrict functions but the controller 11 may use other information to perform authentication and to restrict functions. For example, Active Directory Authentication or LDAP (Lightweight Directory Access Protocol) Authentication may be used. When using Active Directory Authentication, for example, the controller 11 may authenticate a local login to the MFP 10 based on authentication information stored on an Active Directory (U.S. trademark of Microsoft Corporation) server. The controller 11 may also restrict scan functions and the like using restriction settings for individual users stored on the Active Directory server. When using LDAP Authentication, the controller 11 may authenticate local logins to the MFP 10 based on authentication information stored on a Lightweight Directory Access Protocol (LDAP) server. The controller 11 may also restrict functions using restriction settings stored on the LDAP server. The above methods of authentication and restriction may be used in combination or may be switched. Further, authentication information may be stored in a different storage from the restriction settings. For example, the controller 11 may authenticate local logins to the MFP 10 based on authentication information stored on a server and may record restriction settings in the SFL database 19 stored in the memory 12.

In the embodiment described above, the SFL feature may be enabled or disabled through a web page sent by the controller 11 of the MFP 10 on the PC 40. As an alternative, the user may enable or disable the SFL feature through operations on the user interface 16 of the MFP 10. Hence, the controller 11 may receive modifications to restrictions and the like in response to operations performed through the user interface 16 in the same way that modifications were made through the web page.

While the restriction value recorded in the SFL database 19 for the “Scan” function is applied to both push scans and pull scans in the above embodiment, a checkbox may be provided for each type of the pull scan and push scan so that the controller 11 can accept a separate restriction value for each.

The MFP 10 is an example of the reading device. However, the reading device is not limited to the MFP 10. The reading device may be any device having a scanning function. The reading device may be a device only have a scanning function.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A reading device comprising:
a scanner;
a user interface; and
a controller,
wherein the controller is configured to perform:
receiving an execution instruction issued from an external device, the execution instruction instructing the controller to perform a pull scan, the pull scan including: controlling the scanner to read an original to generate scan data based on the original; and returning the scan data to the external device;
starting a first pull scan, the first pull scan being the pull scan based on the execution instruction and started under a pull scan start condition, the pull scan start condition including a requirement that first user authentication information is received in association with the execution instruction; and
cancelling the started first pull scan under a first cancellation condition, the first cancellation condition including: a requirement that a cancellation instruction to cancel the pull scan is received through the user interface after starting the first pull scan; a requirement that second user authentication information is received through the user interface in association with the cancellation instruction; and a requirement that the second user authentication information corresponds to the first user authentication information received in association with the execution instruction,
wherein despite receiving the cancellation instruction after starting the first pull scan, the controller continues the first pull scan under a first continuation condition, the first continuation condition including: a requirement that the cancellation instruction is received through the user interface; a requirement that the second user authentication information is received through the user interface in association with the cancellation instruction; and a requirement that the second user authentication information does not correspond to the first user authentication information received in association with the execution instruction.

2. The reading device according to claim 1, wherein the controller performs the cancelling the first pull scan under the first cancellation condition, the first cancellation condition further including: a requirement that after starting the first pull scan, the cancellation instruction is received through the user interface with the reading device in a locally logged-out state in which no user is locally logged in to the reading device; and a requirement that the second user authentication information is received through the user interface subsequently to reception of the cancellation instruction, in addition to the requirement that the second user authentication information corresponds to the first user authentication information received in association with the execution instruction,
wherein the controller continues the first pull scan under the first continuation condition, the first continuation condition further including: a requirement that after starting the first pull scan, the cancellation instruction is received through the user interface with the reading device in the locally logged-out state; and a requirement that the second user authentication information is received through the user interface subsequently to reception of the cancellation instruction, in addition to the requirement that the second user authentication information does not correspond to the first user authentication information received in association with the execution instruction.

3. The reading device according to claim 2, wherein the controller performs the starting the first pull scan under the pull scan start condition, the pull scan start condition further including a requirement that the execution instruction is received with the reading device in the locally logged-out state,
wherein the controller performs the cancelling the first pull scan under the first cancellation condition, the first cancellation condition further including a requirement that the second user authentication information is received through the user interface with the locally logged-out state maintained since receipt of the execution instruction, in addition to the requirement that the second user authentication information corresponds to the first user authentication information received in association with the execution instruction,
wherein the controller continues the first pull scan under the first continuation condition, the first continuation condition further including a requirement that the second user authentication information is received through the user interface with the locally logged-out state maintained since receipt of the execution instruction, in addition to the requirement that the second user authentication information does not correspond to the first user authentication information received in association with the execution instruction.

4. The reading device according to claim 3, wherein the controller is configured to further perform:
starting a second pull scan, the second pull scan being the pull scan based on the execution instruction and started under a second pull scan start condition, the second pull scan start condition including: a requirement that the execution instruction is received with the reading device in a locally logged-in state in which a user, as a locally-logged-in user, is locally logged in to the reading device based on third user authentication information received through the user interface; a requirement that the first user authentication information is received in association with the execution instruction; and a requirement that the first user authentication information corresponds to the third user authentication information,
wherein the controller does not start the second pull scan under a second-pull-scan restriction condition, the second-pull-scan restriction condition including a requirement that the execution instruction is received with the reading device in the locally logged-in state; a requirement that the first user authentication information is received in association with the execution instruction; and a requirement that the first user authentication information does not correspond to the third user authentication information,
wherein once the second pull scan has been started, the controller does not receive any operation to change the locally-logged-in user until the second pull scan is completed or cancelled.

5. The reading device according to claim 1, wherein the controller performs the cancelling the first pull scan under the first cancellation condition, the first cancellation condition further including: a requirement that after starting the first pull scan, the cancellation instruction is received through the user interface with the reading device in a locally logged-out state in which no user is locally logged in to the reading device; and a requirement that the second user authentication information is received through the user interface subsequently to reception of the cancellation instruction, in addition to the requirement that the second user authentication information corresponds to the first user authentication information received in association with the execution instruction,
wherein the controller continues the first pull scan under the first continuation condition, the first continuation condition further including: a requirement that after starting the first pull scan, the cancellation instruction is received through the user interface with the reading device in the locally logged-out state; and a requirement that the second user authentication information is received through the user interface subsequently to reception of the cancellation instruction, in addition to the requirement that the second user authentication information does not correspond to the first user authentication information received in association with the execution instruction,
wherein the controller is configured to further perform:
cancelling the started first pull scan under a second cancellation condition, the second cancellation condition including: a requirement that after starting the first pull scan, the cancellation instruction is received through the user interface with the reading device in a locally logged-in state in which a user, as a locally-logged-in user, is locally logged in to the reading device based on third user authentication information received through the user interface; and a requirement that the first user authentication information corresponds to the third user authentication information,
wherein despite receiving the cancellation instruction after starting the first pull scan, the controller continues the first pull scan under a second continuation condition, the second continuation condition including: a requirement that after starting the first pull scan, the cancellation instruction is received through the user interface with the reading device in the locally logged-in state; and a requirement that the first user authentication information does not correspond to the third user authentication information.

6. The reading device according to claim 1, wherein the controller performs the starting the first pull scan under the pull scan start condition, the pull scan start condition further including a requirement that the execution instruction is received with the reading device in a locally logged-in state in which a user, as a locally-logged-in user, is locally logged in to the reading device based on third user authentication information received through the user interface; and a requirement that the first user authentication information corresponds to the third user authentication information,
wherein the controller does not start the first pull scan under a first-pull-scan restriction condition, the first-pull-scan restriction condition including a requirement that the execution instruction is received with the reading device in the locally logged-in state; and a requirement that the first user authentication information does not correspond to the third user authentication information,
wherein the controller performs the cancelling the first pull scan under the first cancellation condition, the first cancellation condition further including a requirement that the cancellation instruction is received through the user interface with the locally logged-in state maintained since receipt of the execution instruction, in addition to the requirement that the first user authentication information corresponds to the third user authentication information,
wherein the controller continues the first pull scan under the first continuation condition that includes the requirement that the first user authentication information does not correspond to the third user authentication information.

7. The reading device according to claim 6, wherein once the first pull scan has been started, the controller does not receive any operation to transition the reading device to a locally logged-out state until the first pull scan is completed or cancelled, the locally logged-out state being a state in which no user is locally logged in to the reading device.

8. The reading device according to claim 1, wherein the controller is configured to further perform:
receiving a push scan execution instruction based on an operation through the user interface, the push scan execution instruction instructing the controller to perform a push scan, the push scan including: reading the original to generate the scan data; and sending the scan data to a destination designated through the user interface;
starting the push scan under a push scan start condition including a requirement that the push scan execution instruction is received based on the operation through the user interface; and
cancelling the started push scan under a push scan cancellation condition without receiving any user authentication information through the user interface, the push scan cancellation condition including a requirement that a push scan cancellation instruction is received through the user interface after starting the push scan,
wherein the controller cancels the started first pull scan under the first cancellation condition, the first cancellation condition including: the requirement that the cancellation instruction to cancel the pull scan is received through the user interface after starting the first pull scan; the requirement that the second user authentication information is received through the user interface in association with the cancellation instruction; and the requirement that the second user authentication information corresponds to the first user authentication information received in association with the execution instruction,
wherein the controller continues the first pull scan under the first continuation condition, the first continuation condition including: the requirement that the cancellation instruction is received through the user interface; the requirement that the second user authentication information is received through the user interface in association with the cancellation instruction; and the requirement that the second user authentication information does not correspond to the first user authentication information received in association with the execution instruction.

9. The reading device according to claim 8, wherein the controller performs the starting the push scan under the push scan start condition, the push scan start condition further including a requirement that the push scan execution instruction is received based on the operation through the user interface with the reading device in a locally logged-out state in which no user is locally logged in to the reading device,
wherein the controller performs the cancelling the started push scan under the push scan cancellation condition without receiving any user authentication information through the user interface, the push scan cancellation condition further including a requirement that the push scan cancellation instruction is received with the locally logged-out state maintained since receipt of the push scan execution instruction,
wherein the controller performs the starting the first pull scan under the pull scan start condition, the pull scan start condition further including a requirement that the execution instruction is received with the reading device in the locally logged-out state,
wherein the controller performs the cancelling the first pull scan under the first cancellation condition, the first cancellation condition further including a requirement that the second user authentication information is received through the user interface in association with the cancellation instruction with the locally logged-out state maintained since receipt of the execution instruction, in addition to the requirement that the second user authentication information corresponds to the first user authentication information received in association with the execution instruction,
wherein the controller continues the first pull scan under the first continuation condition that includes the requirement that the second user authentication information does not correspond to the first user authentication information received in association with the execution instruction.

10. The reading device according to claim 1, wherein the controller is configured to further perform:
cancelling the started first pull scan under a second cancellation condition without receiving any user authentication information through the user interface, the second cancellation condition including a requirement that the cancellation instruction is received from the external device that is a transmission source of the execution instruction,
wherein the controller performs the cancelling the started first pull scan under the first cancellation condition, the first cancellation condition including: the requirement that the cancellation instruction is received through the user interface after starting the first pull scan; the requirement that the second user authentication information is received through the user interface in association with the cancellation instruction; and the requirement that the second user authentication information corresponds to the first user authentication information received in association with the execution instruction,
wherein the controller continues the first pull scan under the first continuation condition, the first continuation condition including: the requirement that the cancellation instruction is received through the user interface; the requirement that the second user authentication information is received through the user interface in association with the cancellation instruction; and the requirement that the second user authentication information does not correspond to the first user authentication information received in association with the execution instruction.

11. The reading device according to claim 1, wherein the controller is configured to further perform:
starting a second pull scan, the second pull scan being the pull scan based on the execution instruction and started without receiving any user authentication information in association with the execution instruction; and
cancelling the started second pull scan based on the cancellation instruction received through the user interface without receiving any user authentication information through the user interface,
wherein the controller performs the cancelling the started first pull scan under the first cancellation condition, the first cancellation condition including: the requirement that the cancellation instruction is received through the user interface after starting the first pull scan; the requirement that the second user authentication information is received through the user interface in association with the cancellation instruction; and the requirement that the second user authentication information corresponds to the first user authentication information received in association with the execution instruction,
wherein the controller continues the first pull scan under the first continuation condition, the first continuation condition including: the requirement that the cancellation instruction is received through the user interface; the requirement that the second user authentication information is received through the user interface in association with the cancellation instruction; and the requirement that the second user authentication information does not correspond to the first user authentication information received in association with the execution instruction.

12. The reading device according to claim 1, wherein the controller is configured to further perform:
cancelling the started first pull scan under a second cancellation condition, the second cancellation condition including: a requirement that the cancellation instruction is received through the user interface after starting the first pull scan; a requirement that the second user authentication information is received through the user interface in association with the cancellation instruction; and a requirement that the second user authentication information corresponds to user authentication information of an administrator of the reading device even when the second user authentication information does not correspond to the first user authentication information received in association with the execution instruction,
wherein the controller continues the first pull scan under the first continuation condition, the first continuation condition further including a requirement that the second user authentication information corresponds to neither the first user authentication information nor the user authentication information of the administrator of the reading device.

13. The reading device according to claim 1, wherein the controller is configured to further perform:
a re-entry reception process of receiving re-entered user authentication information through the user interface when the second user authentication information received in association with the cancellation instruction does not correspond to the first user authentication information received in association with the execution instruction, the re-entry reception process being repeated up to a maximum permitted number of times while the re-entered user authentication information does not correspond to the first user authentication information,
wherein the controller continues the first pull scan under the first continuation condition, the first continuation condition further including at least one of a first requirement set and a second requirement set, the first requirement set including a requirement that the second user authentication information does not correspond to the first user authentication information; and a requirement that no re-entered user authentication information corresponds to the first user authentication information after the re-entry reception process is performed the maximum permitted number of times, the second requirement set including a requirement that a prescribed time period elapses from a specific point in time without receiving any user authentication information corresponding to the first user authentication information, the specific point in time being a point in time after the execution instruction is received.

14. The reading device according to claim 1, wherein despite receiving the cancellation instruction after starting the first pull scan, the controller continues the first pull scan under a second continuation condition, the second continuation condition including: a requirement that the cancellation instruction is received through the user interface; and a requirement that a prescribed time period elapses from a specific point in time without receiving any user authentication information corresponding to the received first user authentication information through the user interface in association with the cancellation instruction, the specific point in time being a point in time after the execution instruction is received.

15. The reading device according to claim 14, wherein the controller continues the first pull scan under the second continuation condition, the second continuation condition further including a requirement that the prescribed time period is shorter than a timeout period of an established communication between the reading device and the external device as a transmission source of the execution instruction, in addition to the requirement that the prescribed time period elapses from the specific point in time without receiving any user authentication information corresponding to the received first user authentication information through the user interface in association with the cancellation instruction.

16. The reading device according to claim 15, wherein the controller is configured to further perform:
acquiring information related to the timeout period,
wherein the controller continues the first pull scan under the second continuation condition, the second continuation condition further including a requirement that the prescribed time period is a time period shorter than the timeout period based on the received information related to the timeout period, in addition to the requirement that the prescribed time period elapses from the specific point in time without receiving any user authentication information corresponding to the received first user authentication information through the user interface in association with the cancellation instruction.

17. The reading device according to claim 1, wherein the controller is configured to further perform:
requesting the external device that is a transmission source of the execution instruction to extend a timeout period of an established communication between the reading device and the external device by an extension period; and
acquiring timeout information related to the timeout period or an extended time period, the extended time period being a sum of the timeout period and the extension period,
wherein despite receiving the cancellation instruction after starting the first pull scan, the controller continues the first pull scan under a second continuation condition, the second continuation condition including: a requirement that the cancellation instruction is received through the user interface; a requirement that a prescribed time period elapses from a specific point in time without receiving any user authentication information corresponding to the received first user authentication information through the user interface in association with the cancellation instruction; and a requirement that the prescribed time period is set as a time period shorter than the extended time period based on the timeout information, the specific point in time being a point in time after the execution instruction is received.

18. The reading device according to claim 1, further comprising:
a memory,
wherein an established communication between the reading device and the external device is cancelled in a case where a specific state has continued for a timeout period, the specific state being a state in which the reading device does not transmit any part of the scan data generated in the first pull scan to the external device,
wherein the controller is configured to further perform:
in response to reception of the cancellation instruction, temporarily halting transmission of generated part of the scan data to the external device and storing the generated part of the scan data in the memory,
wherein the controller continues the first pull scan by resuming the transmission of the generated part of the scan data stored in the memory to the external device under the first continuation condition, the first continuation condition including the requirement that the second user authentication information does not correspond to the first user authentication information received in association with the execution instruction,
wherein when the controller cancels the first pull scan under the first cancellation condition including the requirement that the second user authentication information corresponds to the first user authentication information received in association with the execution instruction, the controller cancels the transmission of the generated part of the scan data stored in the memory.

19. The reading device according to claim 1, wherein the controller is configured to further perform:
requesting the external device that is a transmission source of the execution instruction to extend a timeout period of an established communication between the reading device and the external device by an extension period under a request condition, the request condition including: a requirement that the execution instruction is received from the external device; and a requirement that user authentication is required to start the pull scan based on the execution instruction.

20. The reading device according to claim 1, wherein an established communication between the reading device and the external device is cancelled in a case where a specific state has continued for a timeout period, the specific state being a state in which the reading device does not transmit any part of the scan data generated in the first pull scan to the external device,
wherein the controller is configured to further perform:
displaying a user list on the user interface after the first pull scan has been started, the user list including one or more user identifiers of one or more users that can log in to the reading device;
receiving a selection operation to select one user identifier from the one or more user identifiers in the user list; and
receiving user authentication information of the selected one user identifier as the second user authentication information received through the user interface,
wherein the controller cancels the first pull scan under the first cancellation condition, the first cancellation condition further including a requirement that the user authentication information of the selected one user identifier received as the second user authentication information corresponds to the first user authentication information,
wherein the controller continues the first pull scan under the first continuation condition, the first continuation condition including a requirement that the user authentication information of the selected one user identifier received as the second user authentication information does not correspond to the first user authentication information.

21. The reading device according to claim 1, wherein the controller is configured to further perform:
displaying a user list on the user interface after the first pull scan has been started, the user list including one or more user identifiers of one or more users that have permission to cancel the first pull scan;
receiving a selection operation to select one user identifier from the one or more user identifiers in the user list; and
receiving a password associated with the selected one user identifier, a combination of the selected one user identifier and the password being set as the second user authentication information received through the user interface,
wherein the controller cancels the first pull scan under the first cancellation condition, the first cancellation condition further including a requirement that the combination of the selected one user identifier and the password as the second user authentication information corresponds to the first user authentication information,
wherein the controller continues the first pull scan under the first continuation condition, the first continuation condition including a requirement that the combination of the selected one user identifier and the password as the second user authentication information does not correspond to the first user authentication information.

22. The reading device according to claim 1, wherein the controller is configured to further perform:
determining whether an error has occurred on the reading device; and
cancelling the started first pull scan without receiving any user authentication information through the user interface when the determining determines that the error has occurred on the reading device.
